(19) United States
(12) Patent Application Publication
(10) Pub. No.: US 2020/0320606 A1
(43) Pub. Date: Oct. 8, 2020

(54) ELECTRONIC PALETTE APPARATUS AND METHODS

(71) Applicant: Material Technologies, LLC, New York, NY (US)

(72) Inventor: Adam I. SANDOW, Boca Raton, FL (US)

(73) Assignee: Material Technologies, LLC, New York, NY (US)

(21) Appl. No.: 16/838,269

(22) Filed: Apr. 2, 2020

Related U.S. Application Data
(60) Provisional application No. 62/828,192, filed on Apr. 2, 2019.

(51) Int. Cl. G06Q 30/06

(52) U.S. Cl. CPC G06Q 30/0629; G06Q 30/0621; G06Q 30/0643

(57) ABSTRACT

An electronic design system and corresponding methods are disclosed. The electronic design system may include a computing device that allows for users to associate material swatches to material boards where a user can manage and sort the material swatches. The computing device allows a user to search for materials based on user input or pre-configured filters. The computing device also allows for the automatic ordering of samples of materials associated with the material swatches, such as to a supplier of the material, and may automatically associate the ordered material with a representative of the supplier. The electronic design system may also allow users to share material boards across various user accounts. In some examples, the electronic design system includes a swatch presentation device that provides data to the computing device. The computing device may determine material data for a material associated with the swatch presentation device.

### CROSS-REFERENCE TO RELATED APPLICATIONS

This application claims the benefit of U.S. Provisional Patent Application No. 62/828,192, filed Apr. 2, 2019, and entitled “ELECTRONIC PALETTE APPARATUS AND METHODS,” which is hereby incorporated by reference in its entirety.

### FIELD OF THE INVENTION

The disclosure relates generally to systems for interior and exterior design and, more particularly, to electronic design palettes.

### BACKGROUND

Manufacturers and suppliers of design materials, such as fabrics, flooring, paints, housewares, or any other design materials, often times provide samples of those design materials. For example, a manufacturer or supplier of a fabric material may provide a small sample of the fabric to a supplier. The sample may include a portion of the design material, an image of the design material, or, in some examples, information about the design material. In addition, the supplier may provide the sample to potential purchasers of the fabric, such as design professionals and end users of the fabric (e.g., homeowners). For example, the supplier may display the sample at a retail location, where potential purchasers of the design material may view the sample. In some examples, the supplier may display an image of the design material online, such as on a website.

### SUMMARY

In some examples, an apparatus comprises a communications unit, a memory device storing instructions, and at least one processor operatively coupled to the communications unit and the memory device. The at least one processor is configured to execute the instructions to generate for display a plurality of material swatch images, wherein each material swatch image is associated with a material. The at least one processor may also execute the instructions to receive a first input identifying a selection of at least one material swatch image of the plurality of material swatch images, and associate the at least one material swatch image with a material board based on receiving the first input. Further, the at least one processor may execute the instructions to receive a second input and, in response to the second input, automatically generate a communication for a sample of the material associated with the at least one material swatch image. The at least one processor may further execute the instructions to transmit, via the communications unit, the communication.

In some examples, a method comprises generating for display a plurality of material swatch images, wherein each material swatch image is associated with a material. The method further comprises receiving a first input identifying a selection of at least one material swatch image of the plurality of material swatch images, and associating the at least one material swatch image with a material board based on receiving the first input. The method further comprises receiving a second input and, in response to the second input, automatically generating a communication for a sample of the material associated with the at least one material swatch image. Further, the method comprises transmitting, via the communications unit, the communication.

In some examples, a non-transitory, machine-readable storage medium stores instructions that, when executed by at least one processor, cause the at least one processor to perform operations comprising generating for display a plurality of material swatch images, wherein each material swatch image is associated with a material. The operations further comprise receiving a first input identifying a selection of at least one material swatch image of the plurality of material swatch images, and associating the at least one material swatch image with a material board based on receiving the first input. The operations also comprise receiving a second input and, in response to the second input, automatically generating a communication for a sample of the material associated with the at least one material swatch image. Further, the operations comprise transmitting, via the communications unit, the communication.

In some examples, a system comprises a swatch presentation device, a database, and at least one processor operatively coupled to a memory device storing instructions. The at least one processor is configured to execute the instructions to receive, from the swatch presentation device, data identifying the swatch presentation device and determine, based on the received data, a material associated with the swatch presentation device. The at least one processor is also configured to execute the instructions to obtain material data for the determined material from the database, and generate for display material swatch data comprising at least a portion of the obtained material data.

In some examples, a method comprises receiving a first input indicating the selection of a first material swatch image. The method further comprises, in response to receiving the first input: displaying an image of a material associated with the first material swatch image, and displaying an icon at least partially over the image of the material. Further, the method comprises receiving a second input indicating the selection of the icon. In response to receiving the second input, the method comprises obtaining material data for the material, and displaying at least a portion of the obtained material data.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 illustrates an electronic design system that includes an electronic design palette device in accordance with some embodiments;

FIG. 2 illustrates the electronic design palette device of FIG. 1 in accordance with some embodiments;

FIGS. 3A, 3B, 4, 5A, 5B, 5C, 6, 7A, 7B, 7C, 8, 9, 10, 11, 15A, and 15B illustrate various views of an electronic design palette generated by the electronic design palette device of FIG. 1 in accordance with some embodiments;

FIG. 12 illustrates the electronic design palette device of FIG. 1 in communication with a swatch presentation device in accordance with some embodiments;

FIG. 13 illustrates a flowchart of an example method that can be carried out by the electronic design palette device of FIG. 1 in accordance with some embodiments;

FIG. 14 illustrates a flowchart of another example method that can be carried out by the electronic design palette device of FIG. 1 in accordance with some embodiments; and

FIGS. 16A, 16B, 17, 18, 19, 20A, 20B, 20C, 21, 22A, 22B, 23A, 23B, 24, 25A, 25B, 25C, 26A, 26B, 26C, 27, and 28 illustrate various views of an electronic design palette generated by the electronic design palette device of FIG. 1 in accordance with some embodiments.

### DETAILED DESCRIPTION

The description of the preferred embodiments is intended to be read in connection with the accompanying drawings, which are to be considered part of the entire written description of these disclosures. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise, and includes terms such as “directly” coupled, secured, etc. The term “operatively coupled” is such an attachment, coupling, or connection that allows the pertinent structures to operate as intended by virtue of that relationship.

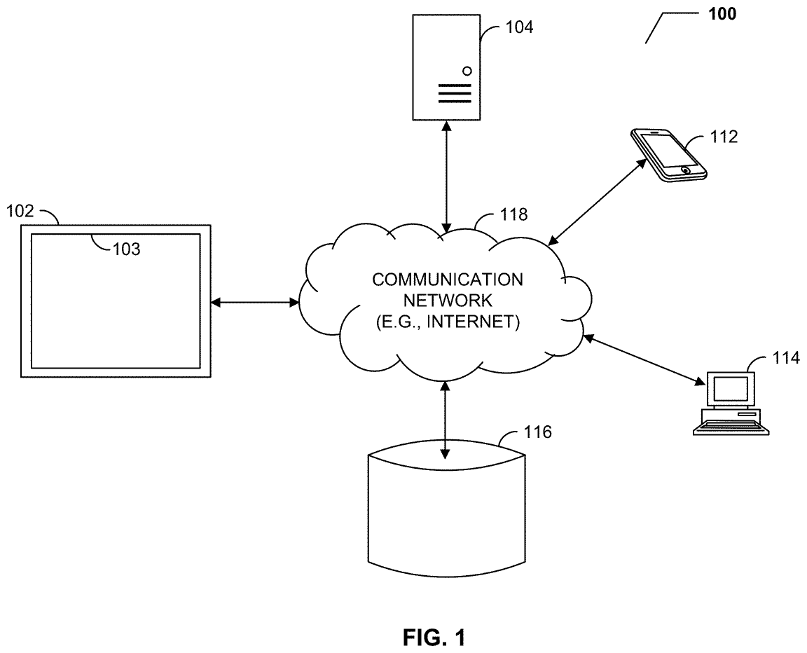

Turning to the drawings, FIG. 1 shows a block diagram of an electronic design system 100 that includes an electronic design palette device 102, a web hosting device 104 (e.g., a web server), database 116, and multiple client computing devices 112, 114 operatively coupled over communication network 118. Communication network 118 can be a WiFi° network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Electronic design palette device 102, web hosting device 104, and multiple client computing devices 112, 114 may each include hardware or hardware and software for processing and handling information. In addition, each may transmit data to, and receive data from, communication network 118. For example, each of electronic design palette device 102, web hosting device 104, and multiple client computing devices 112, 114 may include one or more processors, one or more field-programmable gate arrays (FPGAs), one or more application-specific integrated circuits (ASICs), one or more state machines, digital circuitry, or any other suitable circuitry. In some examples, web hosting device 104 may be, for example, a web server, an application server, a cloud-based server, or any other suitable computing device. In some examples, each of multiple client computing devices 112, 114 may be a workstation, a laptop, a mobile device such as a cellular phone, or any other suitable computing device. Although FIG. 1 illustrates two client computing devices 112, 114, electronic design system 100 can include any number of client computing devices 112, 114. Similarly, electronic design system 100 can include any number of web servers 104 and databases 116.

As illustrated, electronic design palette device 102 includes a display 103. In some examples, display 103 may be a touchscreen that can detect the touch of a user. One example is a pressure-sensitive touchscreen display that can detect an input from a user via a physical touch of the pressure-sensitive touchscreen display. Display 103 may also present interface elements (e.g., a graphical user interface), for example, in response to detecting input from the user. In some examples, a gesture provided by the user is detected and, based on the detected gesture, electronic design palette device 102 performs one or more operations. The gesture may be, for example, a single tap input, a double tap input, or a hold input (e.g., a constant touch of more than a pre-determined minimum amount of time, such as 3 seconds, or 2 seconds, or one second). In some examples, electronic design palette device 102 determines the gestures based on detecting a single tap, a double tap, or a hold of display 103, for example.

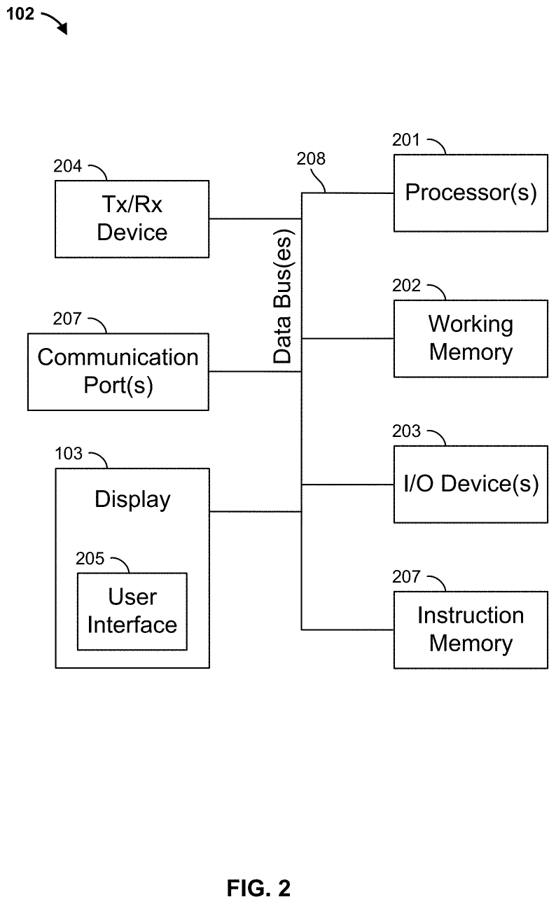

FIG. 2 illustrates more details of electronic design palette device 102. As illustrated in FIG. 2, electronic design palette device 102 may include one or more processors 201, a working memory 202, one or more input/output devices 203, an instruction memory 207, a transceiver 204, one or more communication ports 207, and a display 103, all operatively coupled to one or more data buses 208. Data buses 208 allow for communication among the various devices. Data buses 208 can include wired, or wireless, communication channels.

Processor(s) 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of electronic design palette device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, the communication port(s) 207 allows for the programming of executable instructions in instruction memory 207. In some examples, the communication port(s) 207 allow for the transfer (e.g., uploading or downloading) of data, such as material data stored about materials displayed by the electronic design palette device 102.

Display 103 can display user interface 205. User interfaces 205 can enable user interaction with electronic design palette device 102. For example, user interface 205 can be a user interface for an application that allows for the viewing and manipulation of images of materials as well as material data. In some examples, a user can interact with user interface 205 by engaging input-output devices 203.

Transceiver 204 may be any suitable communication unit that allows for communication with a network, such as communication network 118 of FIG. 1. In some examples, transceiver 204 is selected based on the type of communication network 118 data linkage computing device 102 will be operating in. For example, if communication network 118 of FIG. 1 is a WiFi® network, transceiver 204 is configured to allow communications with the WiFi® network. Processor(s) 201 is operable to receive data from, or send data to, a network, such as communication network 118 of FIG. 1, via transceiver 204.

Turning back to FIG. 1, electronic design palette device 102 is operable to communicate with database 116 over communication network 118. For example, electronic design palette device 102 can store data to, and read data from, database 116. Database 116 may be a tangible, non-transitory memory. For example, database 116 may be a remote storage device, such as a cloud-based server, a memory device on another application server, a networked computer, or any other suitable remote storage. Although shown remote to data linkage computing device 102, in some examples, database 116 can be a local storage device, such as a hard drive, a non-volatile memory, or a USB stick.

In some examples, database 116 stores material data. For example, the material data may identify and characterize materials from various suppliers that may be used in design. The material data may include one or more of an image of the material, a brand, available colors, available sizes, pricing data, material description, physical properties of the material, or any other data related to the material. In some examples, electronic design palette device 102 searches database 116 for materials based on a received search request, such as a request generated based on detecting an input from a user via display 103. In some examples, electronic design palette device 102 searches database 116 for materials based on receiving a transmission from another device, such as from an RFID transmitter. The search request may include materials, material brands, or material categories, for example.

In some examples, electronic design palette device 102 maintains an account for the customer. Each user account may be stored in (e.g., saved to) database 116, for example. For example, electronic design palette device 102 may allow a customer to log into their account using credentials, such as a user name and password. Electronic design palette device 102 may allow a customer to search database 116 for materials, such as design materials, based on material data. For example, electronic design palette device 102 may, in response to a search request, search database 116 for material satisfying the search request. In some examples, electronic design palette device 102 may allow the customer to save search data, or material data, to their account. For example, electronic design palette device 102 may allow the customer to maintain one or more “boards” where the customer can save various design materials to each board.

In some examples, electronic design palette device 102 may allow the customer to order sample materials from one or more suppliers. For example, electronic design palette device 102 may allow the customer to select one or more materials, and submit a request to receive samples for those materials. In some examples, electronic design palette device 102 allows a customer to order multiple materials in response to a single input, such as in response to a single touch or client to display 103.

In some examples, a representative from the supplier of the material is assigned to each order. For example, electronic design palette device 102 may generate a communication, such as an email or short message service (SMS) message, to a computing device operated by a representative of a company that operates electronic design palette device 102. The communication may identify the order, the customer, and the representative. For example, the communication may identify contact information, such as a name, an address, a phone number, or an email address, for the customer and the representative. The communication may be transmitted to both the representative and the customer, for example. Upon receiving the communication, the representative may ship samples of the ordered materials. The samples may be stored in a company's storage facility, such as a logistics hub for the company, for example. In some examples, if an ordered item is out of stock, the representative may cause, via the computing device, the order request to be transmitted to a supplier (e.g., manufacture) of the requested material. The supplier may then ship samples of the ordered materials in accordance with the order.

Web server 104 may host one or more web pages, such as web pages of a company operating electronic design palette device 102. Each client computing device 112, 114 may be operable to access the one or more webpages hosted by web server 104 over communication network 118. For example, a customer operating a client computing device 112, 114 may view a website hosted by web server 104. Electronic design palette device 102 may also be communicatively coupled to web server 104 over network 118. In some examples, web server 104 and electronic design palette device 102 each include a link (e.g., live link) to a same customer account for each customer. As such, activity or operations performed by a customer on one platform can be viewed on the other platform. For example, a customer that generates a board identifying various materials via electronic design palette device 102 may view the same board by accessing a website hosted by web server 104 via, for example, client computing device 112, 114. Similarly, activity performed by a customer on the website hosted by web server 104 may be viewed on the display 103 of electronic design palette device 102.

In some examples, electronic design palette device 102 may configure a customer account, such as by allowing (e.g., enabling) or disallowing (e.g., disabling) one or more features. For example, electronic design palette device 102 may control what materials each account may be able to access or view. In some examples, electronic design palette device 102 may be configured to allow or disallow each of the features discussed herein for each customer account. Merely as an example, a customer may request that only fabric materials of a particular brand may made available on the customer's account. An operator of electronic design palette device 102 may configure the customer's account such that only the particular brand of the fabric material be made available on the customer's account, while still allowing various brands of other types of materials. In some examples, the operator of the electronic design palette device 102 configures each of a plurality of customer accounts based on, for example, customer requests, customer contract agreements, customer support agreements, customer guidelines, or any other reasoning.

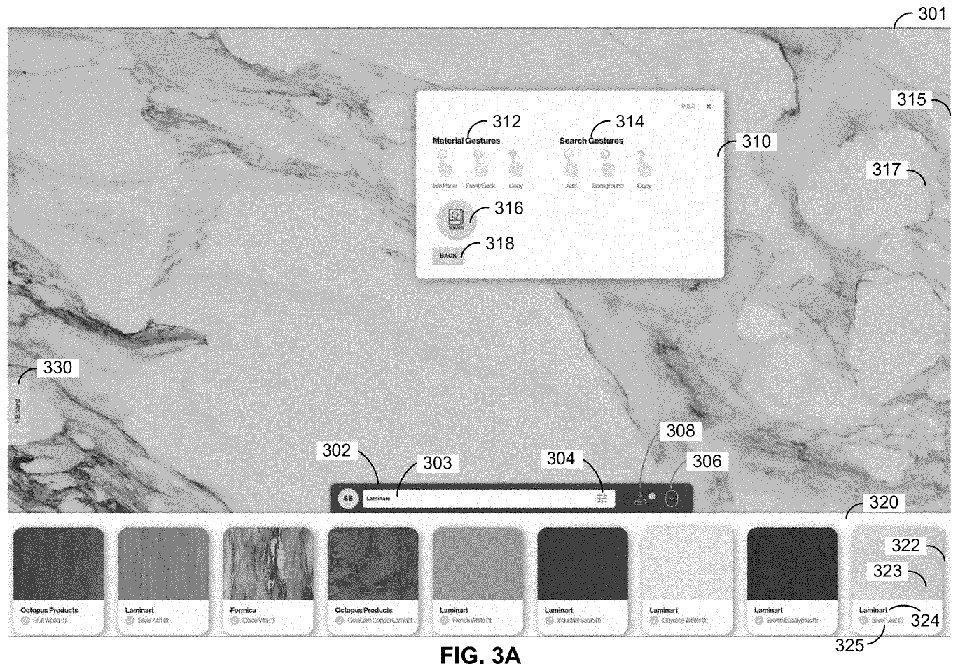

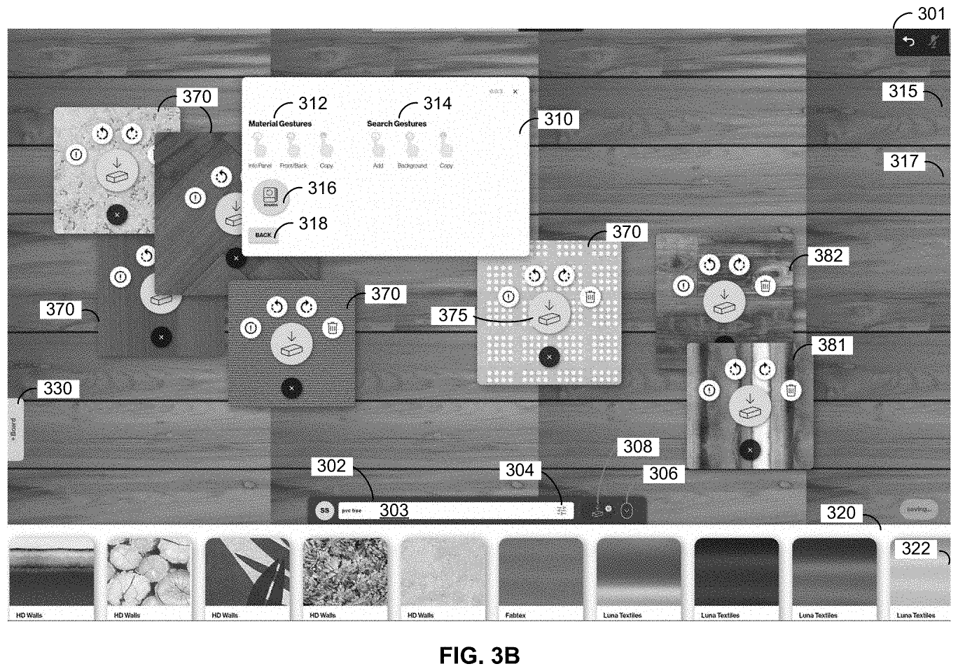

FIGS. 3A and 3B illustrate an electronic design palette 301 that may be generated by electronic design palette device 102 for display on, for example, display 103. In some examples, display 103 is vertically oriented such that electronic design palette 301 is displayed to face upward, such as a table display. Electronic design palette 301 includes a table portion 315 and a material sample portion 320. Material sample portion 320 may display a plurality of images of material samples 322. Each material sample 322 may include, for example, one or more of a material image 323, a supplier 324 (e.g., manufacturer or brand) of the material, and a material property 325, such as a material color, fabric, or any other material property. Data associated with each material sample 322 may be stored in database 116, for example.

In some examples, material sample portion 320 is scrollable. For example, a user may perform a gesture, such as swiping left or right on any portion of material sample portion 320, to scroll among material samples 322. If the user swipes to the left along material sample portion 320, material sample portion 320 may display one or more new material samples 322 (e.g., material samples not currently in view) on the right-hand side of material sample portion 320, and may remove one or more material samples 322 from the left-hand side of material sample portion 320 that were in view before the swipe. If the user swipes to the right along material sample portion 320, material sample portion 320 may display one or more new material samples 322 on the left-hand side of material sample portion 320, and may remove one or more material samples 322 from the right-hand side of material sample portion 320 that were in view before the swipe.

Table portion 315 may display a background image 317. The background image may be of a default material, or a selected material, such as an image associated with a material sample 322. For example, a user may select a material sample 322 by performing a gesture, such as double-tapping on a material sample 322 in material sample portion 320. In response, table portion 315 may display a background image 317 associated with the selected material sample 322. In some examples, background image 317 is an enlarged view of material image 323 of selected material sample 322. In some examples, a user must triple tap the material sample 322 to change the background image 317.

Table portion 315 may also display one or more material swatches 370 as illustrated in FIG. 3B. A user may sort various material swatches 370 within table portion 315. For example, material swatch 370 may be moved from one location within table portion 315 to another location within table portion 315 by dragging (e.g., touching and moving) material swatch 370 from one location to another within table portion 315. Each material swatch 370 may be associated with a selected material sample 322, for example. In some examples, a user may add a material swatch to table portion 315 by performing a gesture, such as single-tapping a material sample 322 from material sample portion 320. In some examples, a user may add a material swatch 370 to table portion 315 by dragging material sample 322 from material sample portion 320 to table portion 315.

In some examples, one material swatch 370 may be displayed at least partially over another material swatch 370. For example, as illustrated in FIG. 3B, material swatch 381 is displayed at least partially over material swatch 382. To bring material swatch 382 to the front (e.g., over any other material swatches 370, 381), a user may perform a gesture, such as double-tapping material swatch 382. In this example, double-tapping material swatch 382 may cause material swatch 382 to be displayed at least partially over material swatch 381 (i.e., double-tapping brings the material swatch 381 to the top). Similarly, to take material swatch 381 to the back (e.g., behind any other material swatches 370, 382), a user may perform a gesture, such as double-tapping material swatch 381. In this example, double-tapping material swatch 381 may cause material swatch 381 to be displayed at least partially behind material swatch 382.

In some examples, a user may cause the duplication of a material swatch by performing a gesture, such as holding material swatch 370. For example, a user may cause a duplicate of material swatch 370 to be displayed within table portion 315 by holding material swatch 370 for a pre-determined, minimum amount of time (e.g., 3 seconds).

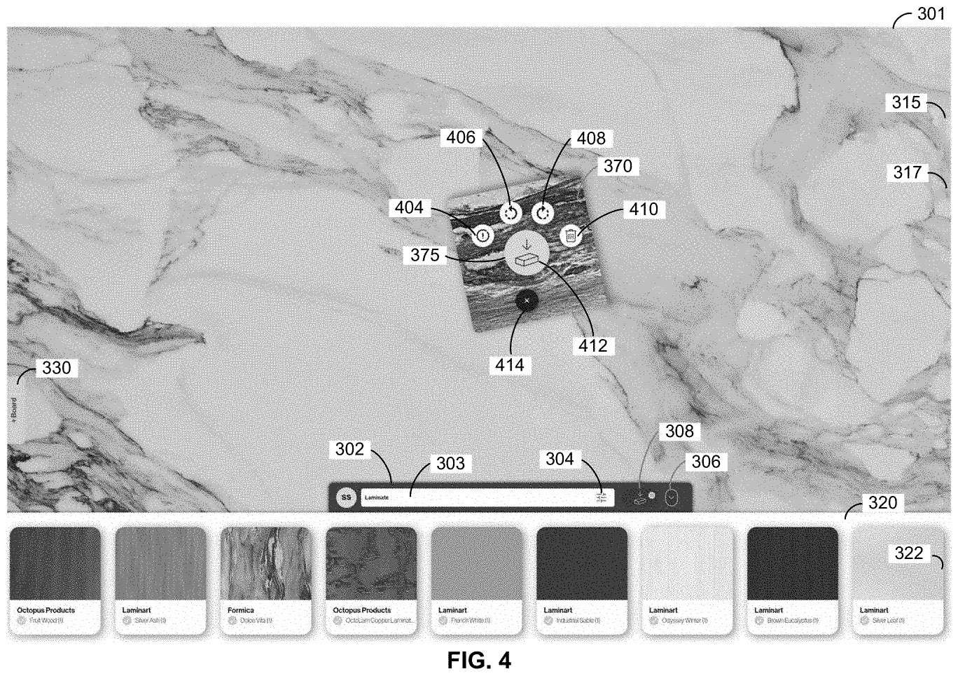

In some examples, as illustrated in FIG. 3B, a material menu 375 is displayed over at least a portion a material swatch 370. For example, a user may cause the display of a material menu 375 for a particular material swatch 370 displayed within table portion 315 by performing a gesture, such as single-tapping the particular material swatch 370. Material swatch 370 and material menu 375 are discussed in further detail with respect to FIG. 4 below.

Table portion 315 may also include a search window 302. Search window 302 may include a search bar 303 where a user may enter one or more search terms to generate material samples 322 that are displayed in material sample portion 320. For example, a user may enter a name of a material, a name of a material brand, a name of a material supplier, a material style, a material category, a material color, or any other data related to a material into search bar 303. In response, electronic design palette device 102 may search database 116 for one or more materials satisfying the search inquiry, and may display material samples 322 associated with the materials satisfying the search inquiry in material sample portion 320. In some examples, when a user performs a gesture, such as single-tapping in search bar 303, a virtual keyboard is displayed. In some examples, the virtual keyboard is displayed when a user taps on expansion icon 306.

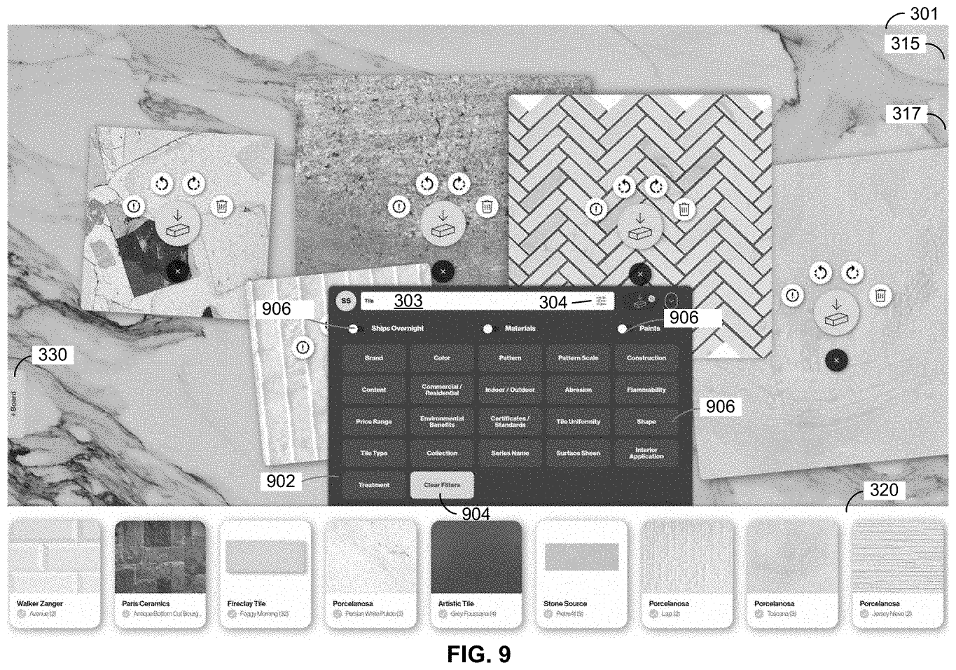

Search window 302 may also include a filter icon 304. When a user taps filter icon 304, a filter menu, such as the filter menu 902 of FIG. 9, is displayed. The filter menu 902 allows a user to select one or more pre-configured filters during a search. For example, by selecting a pre-configured filter, electronic design palette device 102 conducts a search of materials based on the pre-configured filter, such as by searching database 116 for material samples 322 based on one or more search terms associated with the pre-configured filter, as described further with respect to FIG. 9 further below.

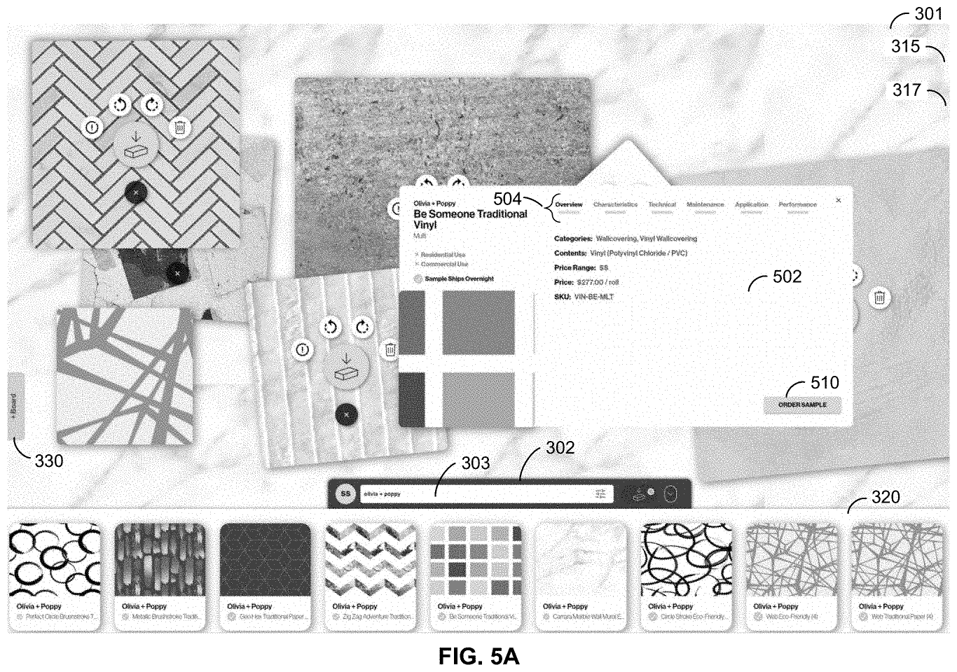

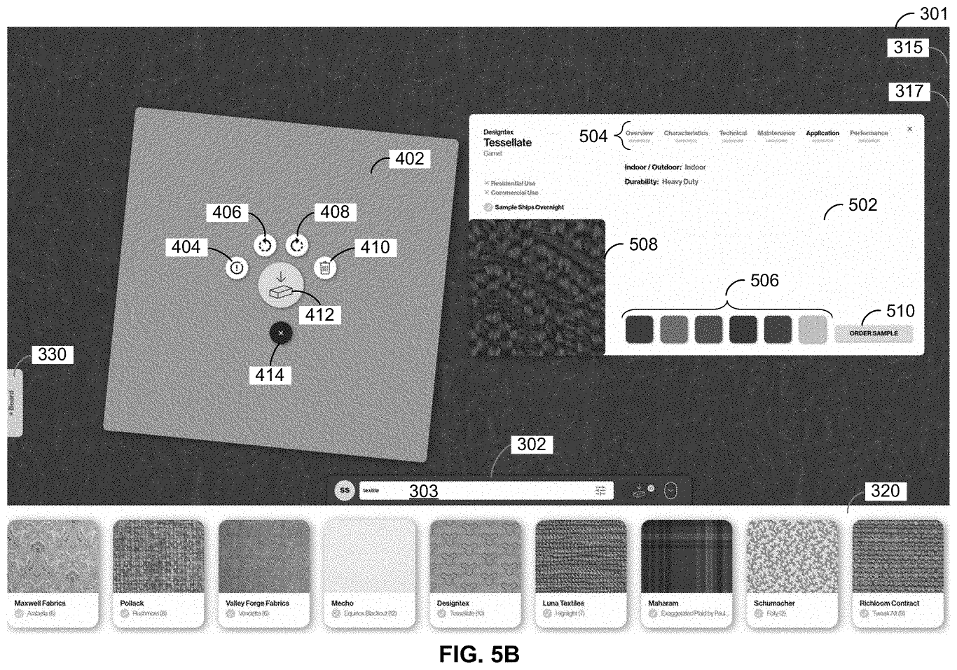

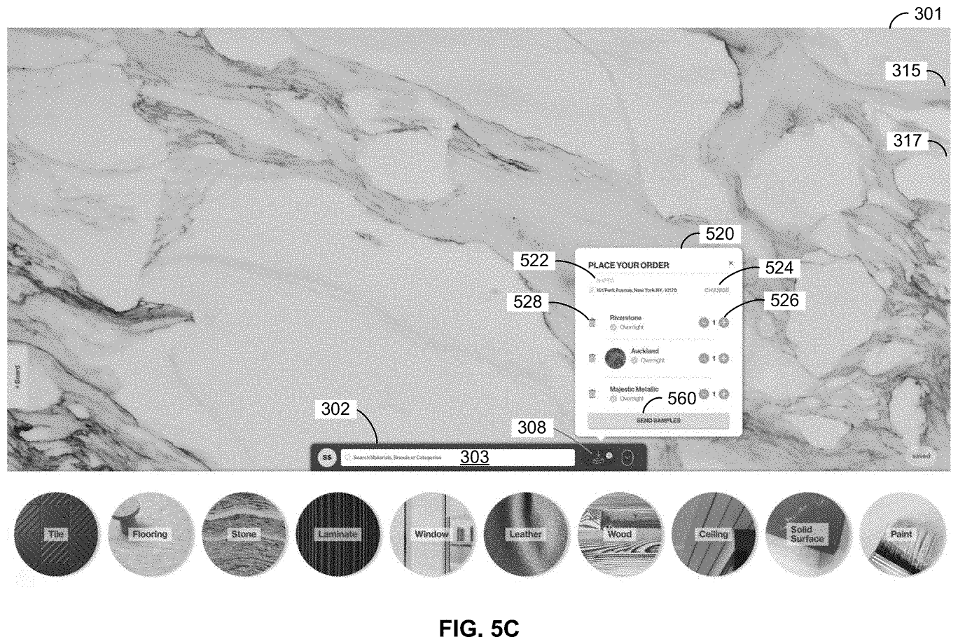

Search window 302 may also include a display order icon 308. Selection (e.g., clicking, tapping, selection) of the display order icon 308 may cause the display of an order request window, such as order request window 520 of FIG. 5C, to be displayed. In some examples, searches are automatically saved to a user's account. For example, a most recent number of searches (e.g., 10) corresponding to a user's active material board may be saved and associated with the active material board, allowing a user to re-run a previous search. In some examples, a user engages a save icon to save a search.

Table portion 315 may also display a board icon 330. Board icon 330 allows for the viewing and selection of a material board, such that selected material swatches 370 are saved to an active material board. Each material board may be associated with a user's account. In some examples, a user may create a plurality of material boards, each material board including one or more saved material swatches 370.

In some examples, as shown in FIG. 3A, a gesture menu 310 may be displayed. Gesture menu 310 may include a display of material gestures 312, which may identify the functions of various gestures performed on a material swatch 370. Gesture menu 310 may also include a display of search gestures 314, which may identify the functions of various gestures performed on a material sample 322 displayed within material sample portion 320.

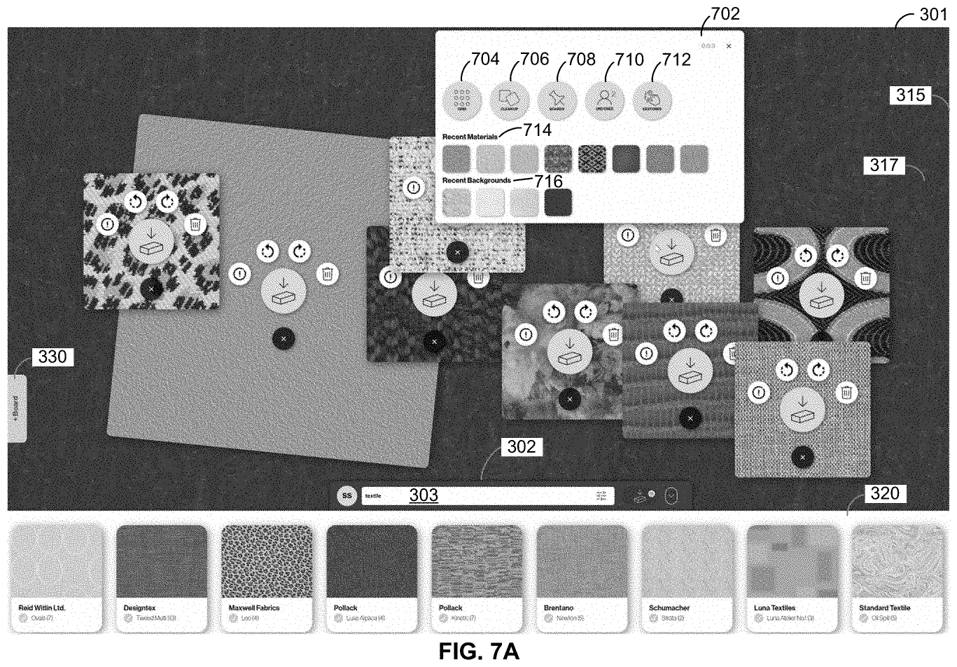

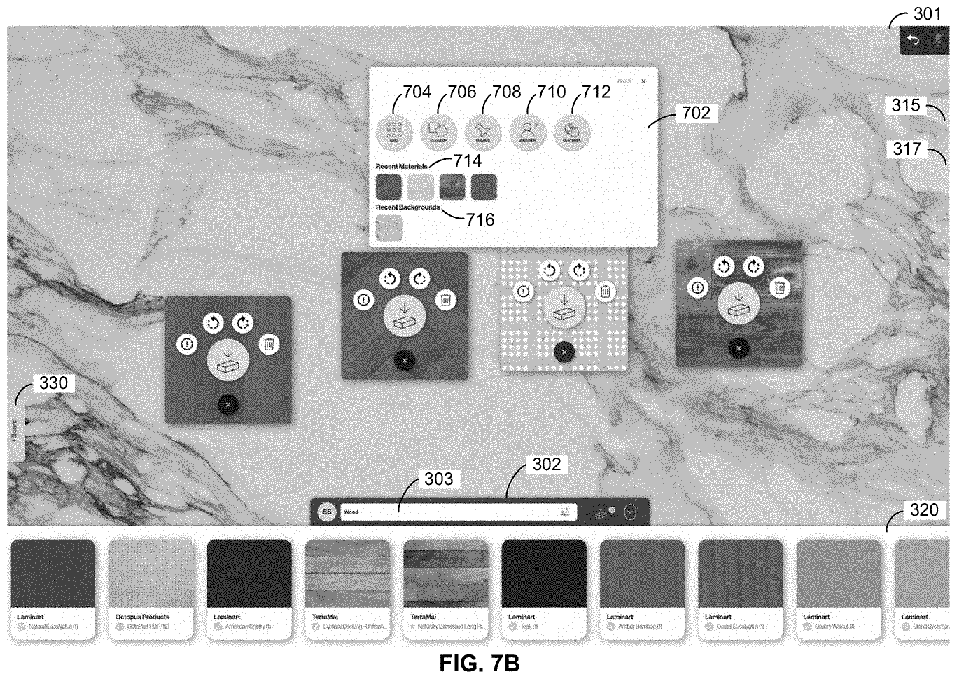

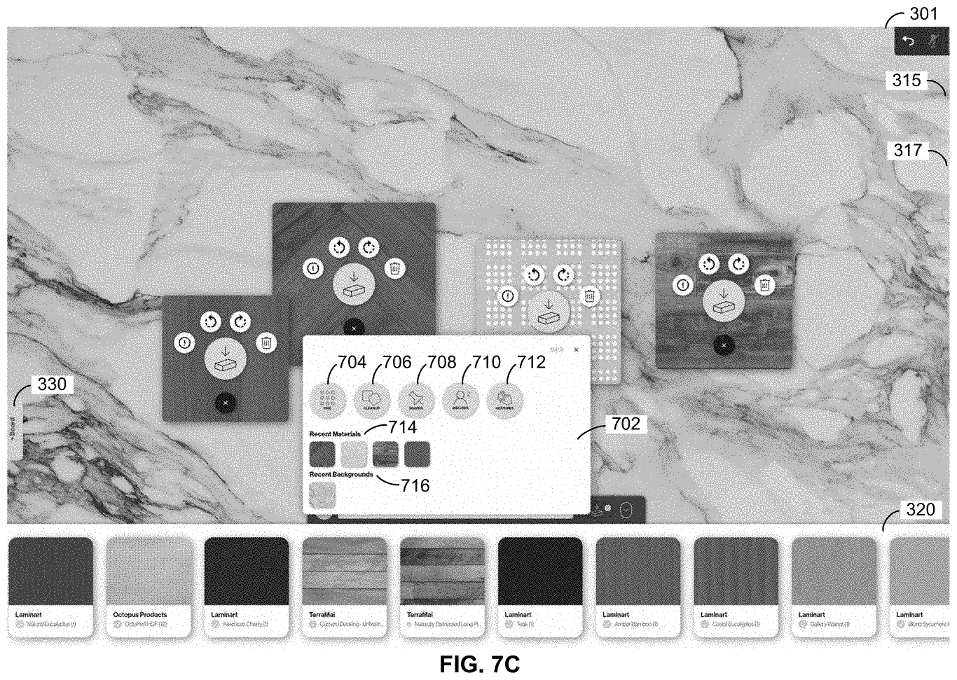

Gesture menu 310 may also include a boards icon 316. Selection of the boards icon 316 may cause the display of a window identifying any material boards associated with a user's account, which is further described below with respect to FIGS. 7A, 7B, and 7C. To cause the gesture menu 310 to be displayed, a user may engage (e.g., by tapping) a gesture icon of a main menu, such as gestures icon 712 of master menu 702 described below with respect to FIGS. 7A, 7B, and 7C. As described below, a user may cause the display of the main menu by performing a gesture, such as by double-tapping on background image 317 of table portion 315. To remove gesture menu 310 from being displayed (e.g., to go back to the main menu), a user may engage back icon 318 as illustrated in FIG. 3A.

FIG. 4 illustrates a material swatch 370 displayed within table portion 315 of electronic design palette 301. As described above, a user may cause a material menu 375 to be displayed over at least a portion of material swatch 370 by performing a gesture, such as single-tapping the material swatch 370. Material menu 375 may include an information icon 404, a rotate-left icon 406, a rotate-right icon 408, a delete icon 410, an add-to-order icon 412, and a remove menu icon 414. Each of the icons may be engaged by a user to effect a corresponding function. For example, a user may tap each of the icons to have corresponding functions take effect.

The selection (also referred to as “engagement”) of each icon causes the execution of a corresponding function. Engagement of the rotate-left icon 406 causes the rotation of material swatch 370 in a counter-clockwise direction (e.g., a configurable number of degrees at a time, such as 5 degrees). For example, in FIG. 4, material swatch 370 appears rotated in a counter-clockwise direction. Engagement of the rotate-right icon 408 causes material swatch 370 to rotate in a clockwise direction (e.g., a configurable number of degrees at a time, such as 5 degrees). Engagement of the delete icon 410 causes the deletion of material swatch 370. The deletion of material swatch 370 may include removing material swatch 370 from being displayed. In some examples, the deletion of material swatch 370 causes the removal of material swatch 370 from a material board, such as the active material board.

Engagement of information icon 404 causes an information menu, such as information menu 502 of FIG. 5A, to be displayed. As described below with respect to FIG. 5A, the information menu may include data related to the material associated with material swatch 370. Engagement of add-to-order icon 412 causes the material associated with material swatch 370 to be added to an order, such as a material sample order. A material sample order is discussed below with respect to FIG. 5B. Engagement of remove menu icon 414 causes the removal of material menu 375 (e.g., material menu 375 is exited).

FIG. 5A illustrates information menu 502 of that is displayed in response to engagement of information icon 404 of material swatch 370. Information menu 502 may include one or more tabs 504. In this example, information menu 502 includes an “Overview” tab, a “Characteristics” tab, a “Technical” tab, a “Maintenance” tab, an “Application” tab, and a “Performance” tab. Information menu 502 may also include addition tabs, such as an “Environmental” tab and a “General” tab, which may be viewed by scrolling the tabs 504 to the right or left, for example. The engagement of each tab 504 may cause data related to material swatch 370 to be displayed.

The “Overview” tab may display overview information of the material associated with material swatch 370. For example, FIG. 5A illustrates the “Overview” tab as the active tab. As illustrated, the “Overview” tab may display category data identifying one or more categories for the corresponding material. In addition, the “Overview” tab may display contents data identifying what the material is made of, a price range (e.g., as identified, in this example, by dollar symbols), a price per quantity, and a stock keeping unit (SKU) identifier for the material.

The “Characteristics” tab may display one or more characteristics of the material associated with material swatch 370. The “Technical” tab may display technical data related to the material associated with material swatch 370, such as fabric composition data. The “Maintenance” tab may display data related to maintenance, such as cleaning, of the material associated with material swatch 370.

The “Application” tab may display how the material can be used. For example, the “Application” tab may identify whether the material may be used indoor vs. outdoor, installation requirements and/or procedures, the durability of the material, details of affixing systems for the material, as well as material applications (i.e. hospitality, healthcare, seating, etc.). The “Application” tab may also display, as illustrated in FIG. 5B, a color option portion 506, and a material image 508.

The “Performance” tab may display data related to performance of the material associated with material swatch 370. For example, the “Performance” tab may display performance characteristics related to stain resistance, hardness, flammability, abrasion/wear resistance, lightfastness, crocking, pilling, seam slippage, tensile strength, tear strength, light reflectance, impact resistance, color stability from heat, or compression.

In some examples, an “Environmental” tab displays environmental data such as environmental benefits (i.e. contains bio-based materials, PV free, formaldehyde free), certificates and standards (i.e. NSF 51 certified), Leadership in Energy and Environmental Design (LEED) information, post-consumer recycled content percentage, post-industrial recycled content percentage, and a list of contents or ingredients.

In some examples, a “General” tab displays general data such as a collection name for the material, material availability, material order increments, country of origin of the material, and warranty information.

Information menu 502 may also include an order sample icon 510. In some examples, the order sample icon 510 is displayed regardless of what tab 504 is currently selected. In some examples, color option portion 506 is displayed regardless of what tab 504 is currently selected. Engagement of the order sample 510, such as a tap of order sample 510, may cause the material associated with information menu 502 to be added to an order.

Referring to FIG. 5C, selection of display order icon 308 causes the display of order request window 520. Order request window 520 may display data identifying all materials added to an order. For example, for each material, order request window 520 may display one or more of a material image, a manufacturer name, a product name, and a project name. For each material, order request window 520 may include a delete icon 528, and quantity selection icons 526. Engagement of delete icon 528 will remove a corresponding material from the order, while engagement of quantity selection icons 526 changes the quantity of material ordered (e.g., a quantity of samples of that material). Order request window 520 may also include an active shipping address 522 (e.g., where the materials being ordered will be shipped), as well as a change address icon 524, which allows a user to change the active shipping address 522. As a user adds, removes, or edits requests in order request window 520, data identifying the activity for the user is stored and saved to the user's shopping cart in a storage device (e.g., networked storage device), such as database 116. If a user were to log in to view their account by accessing a website hosted by web server 104 via, for example, client computing device 112, 114, they would be able to view and access the same shopping cart. For example, regardless of what device, electronic design palette device 102 or client computing device 112, 114, a user uses to create and or edit their shopping cart, the user would be able to access and/or edit the shopping cart from the other device. As another example, the user may add material samples to be ordered via order request window 520 of client computing device 112, 114, and submit the order via a website viewed via client computing device 112, 114.

To request the material identified in order request window 520, a user would engage send samples icon 560. Upon selection of send samples icon 560, a communication, such as an email or SMS (e.g., text) message is transmitted to a representative of the company operating electronic design palette device 102, such as described above. In some examples, and upon selection of send samples icon 560, a communication is transmitted to a representative of the supplier of each ordered material. Each communication may identify the order, the customer, and the representative. For example, each communication may identify contact information, such as a name, an address, a phone number, or an email address, for the customer and the representative. The communication may be transmitted to both the representative and the customer, for example.

In some examples, a user may select an order material board icon, which automatically generates an order for a sample of each material associated with a material swatch 370 that is associated with the active (e.g., current) material board.

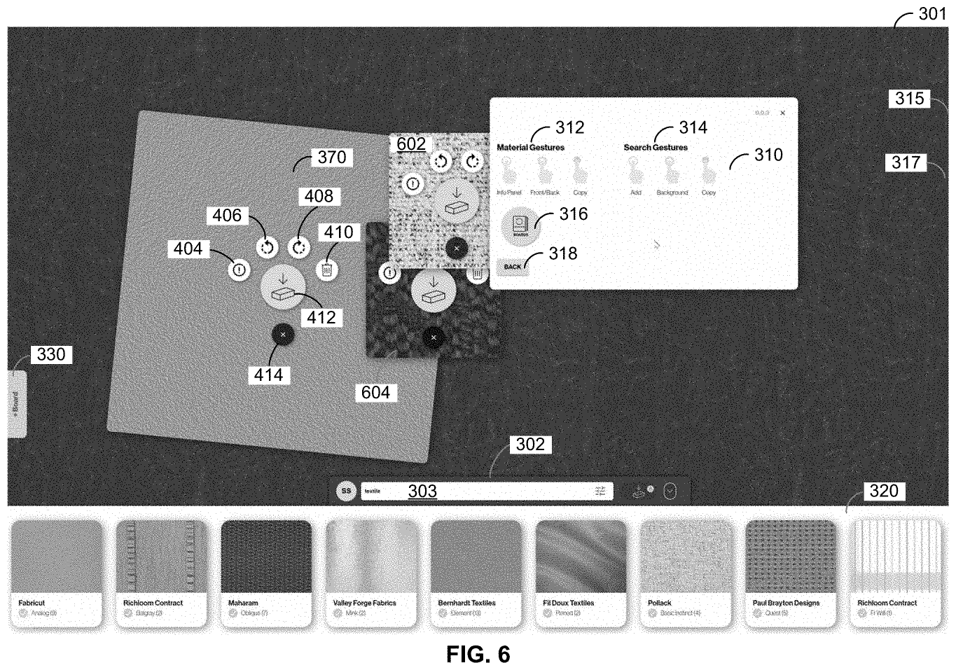

FIG. 6 illustrates a gesture menu 310 at least partially overlaid over material swatch 602 and material swatch 604. Material swatch 602 is at least partially overlaid over material swatch 604 and material swatch 370. Material swatch 604 is at least partially overlaid over material swatch 370. Material swatch 370, in this example, is larger than material swatch 602 and material swatch 604. In some examples, a material swatch 370 may be enlarged by performing a gesture, such as the pinching of two fingers in opposite directions at the same time. In some examples, rather than zooming into the material, the displayed material is displayed larger with the zoom effect of the displayed image remaining the same. To decrease the size of a material swatch 370, a user may perform a different gesture, such as pinching two fingers towards each other. In this example, the size of material swatch 370 is decreased while the zoom effect of the displayed image remains the same. In some examples, the size of the material swatch 370 increases or decreases in the direction of the gestures.

FIGS. 7A, 7B, and 7C illustrate examples of a master menu 702 displayed over background image 317 of table portion 315. A user may cause the display of main menu 702 by performing a gesture, such as by double-tapping on background image 317 of table portion 315. Main menu 702 may include a grid icon 704, a cleanup icon 706, a boards icon 708, a 2^{nd} user icon 710, and a gestures icon 712.

Engagement of grid icon 704 causes the display selection window 802, described below. Engagement of cleanup icon 706 causes all material swatches 370 currently displayed within table portion 315 to display with no rotation. For example, engagement of cleanup icon 706 will cause each material swatch 370 displayed to undo any rotation caused by engaging the rotate-left icon 406 or the rotate-right icon 408 of material menu 375 displayed over material swatch 370.

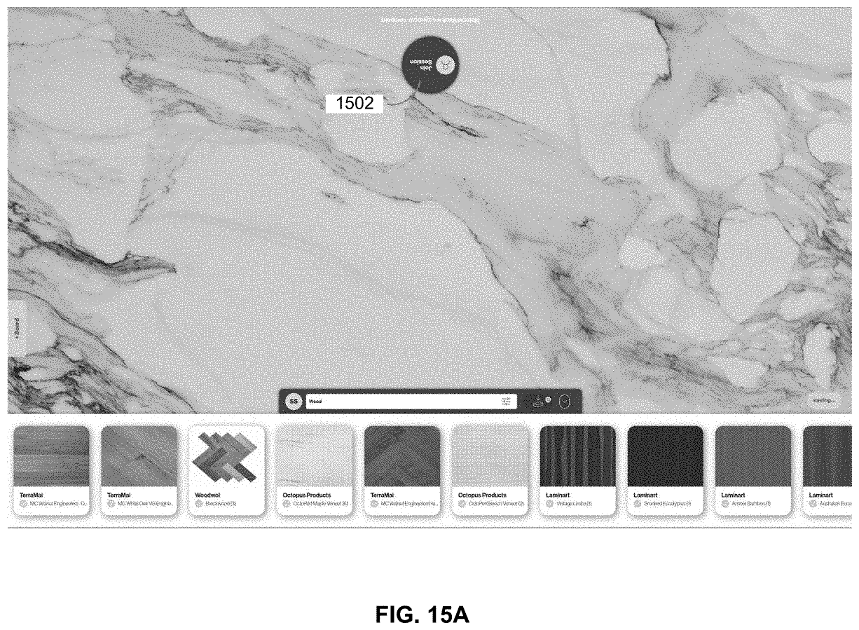

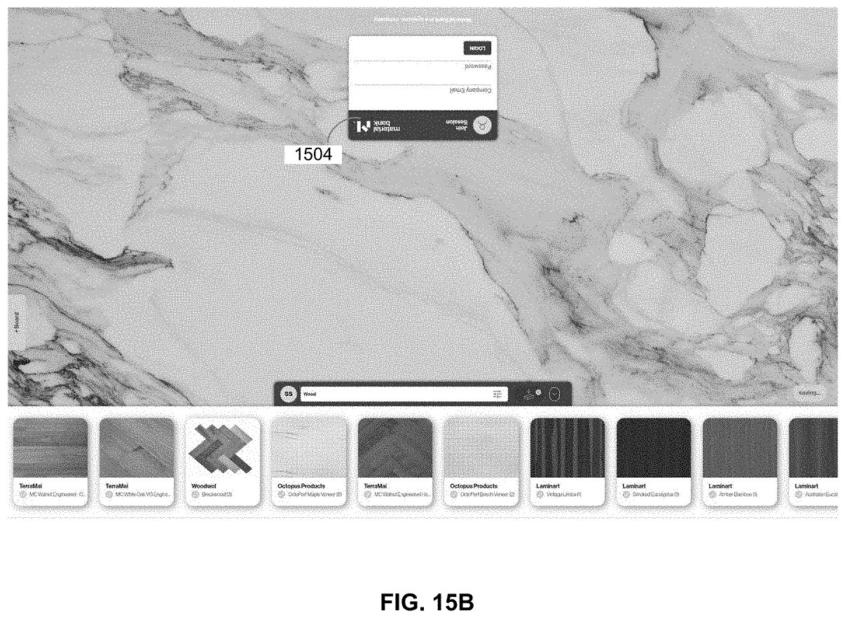

Engagement of boards icon 708 may cause the display of a window identifying any material boards associated with a user's account. For example, the window may display one or more tabs, where each tab identifies a board, such as the boards identified by the engagement of board icon 330. The selection of a tab may activate that board. The tabs may identify boards created by a user when logged into a linked website via client computing device 110, 112, and boards created on electronic design palette device 102. 2^{nd} user icon 710 allows a 2^{nd} user access to a board, such as a board identified by boards icon 708, associated with an account holders account. For example, electronic design palette device 102 may allow a second user to log in by engaging a “Join Session” icon 1502, as illustrated in FIG. 15A. If the user engages the “Join Session” icon 1502, a 2^{nd} user login window 1504 may be displayed as shown in FIG. 15B, allowing the 2^{nd} user to login to a current session of the first user. “Join Session” icon 1502 as well as 2^{nd} user login window 1504 may be displayed such that a 2^{nd} user standing across a first user with respect to electronic design palette 301 views “Join Session” icon 1502 and 2^{nd} user login window 1504 right side up (e.g., while the first user may view them as upside down). As noted above with respect to FIG. 3A, engagement of gestures icon 712 causes the gesture menu 310 to be displayed.

Main menu 702 may also include a recent material portion 714 which indicates the most recent material swatches 370 engaged. In this example, recent material portion 714 displays an image of each material associated with the most recently engaged material swatches 370. In some examples, the recent materials portion 714 is updated to the most recently material swatches 370 that were engaged associated with a material board when a user switches from one material board to another (via, for example, board icon 330).

Main menu 702 may also include a recent backgrounds portion 716 which indicates the most recent background images 317 selected by a user. In this example, recent backgrounds portion 716 displays an image of each material recently selected as background image 317. In some examples, the recent backgrounds portion 716 is updated to the most recent selected backgrounds associated with a selected material board when a user switches from one material board to another (via, for example, board icon 330).

Main menu 702 may be moved from one location within table portion 315 to another location within table portion 315. For example, a user may move main menu 702 by dragging (e.g., touching and moving) main menu 702 from one location to another. As an example, FIG. 7B illustrates main menu 702 in a top, middle portion of table portion 315. A user may drag main menu 702 towards the bottom of table portion 315, resulting in a new location for main menu 702 as illustrated in FIG. 7C.

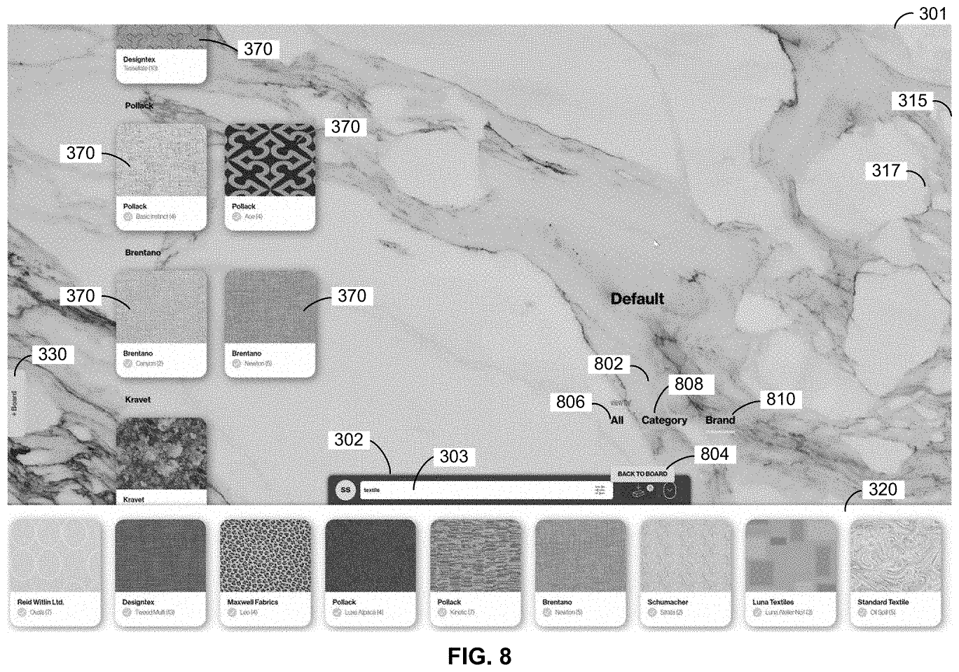

FIG. 8 illustrates a display selection window 802. Display selection window may be displayed when a user engages the grid icon 704 of main menu 702 described above. Display selection window 802 may allow a user to display materials in a predetermined order. In this example, display selection window 802 includes all icon 806, category icon 808, brand icon 810, and back to board icon 804. All icon 806, if engaged, allows a user to view materials by alphabetical order. For example, when engaged, the listed materials are ordered in alphabetical order. Category icon 808 allows a user to view materials by category. For example, if category icon is engaged, the listed materials are ordered by category (e.g., by one or more categories identified in the “Overview” tab of the information menu 502 described above with respect to FIG. 5A). Brand icon 808, when engaged, causes the listed materials to be ordered by category (e.g., by the one or more brands that may be identified in the “Overview” tab of the information menu 502 described above with respect to FIG. 5A). In some examples, the selection of all icon 806, category icon 808, or brand icon 810 also causes material swatches 370 to be displayed within table portion 315 in a grid format (e.g., in equal columns or equal rows). Engagement of back to board icon 804 exits display selection window 802.

FIG. 9 illustrates a filter menu 902 that may be displayed when a user taps filter icon 304 of search window 302. Filter menu 902 may include one or more pre-configured search filters 904 or radio buttons 906 that facilitate a material search. A user may select a pre-configured search filter 904 by engaging (e.g., tapping or touching) it, and may unselect a selected pre-configured search filter 904 by engaging it. The user may select one or more pre-configured search filters 904 to limit a search accordingly. For example, the selection of the “Brand” pre-configured search filter 904 may allow a user to limit a search to one or more particular material brands. Similarly, the selection of the “Color” pre-configured search filter 904 may allow a user to limit a search to one or more material colors, whereas the “Pattern” pre-configured search filter 904 may allow a user to limit a search to one or more material patterns.

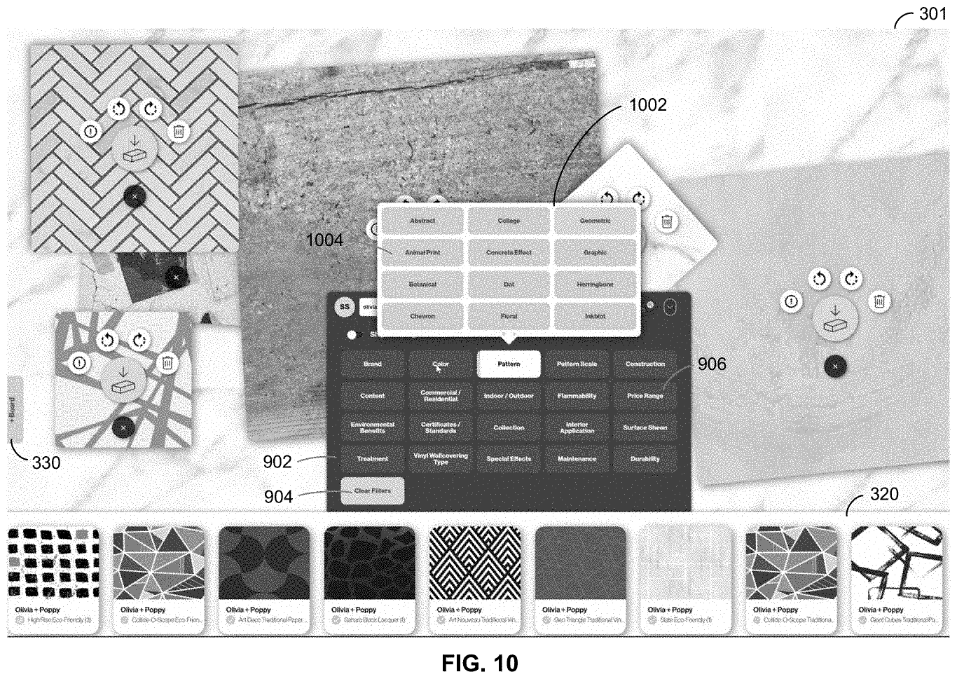

When a user selects a pre-configured search filter 904, a filter menu window, such as filter menu window 1002 in FIG. 10, is displayed. Filter menu window 1002 allows for a selection of one or more sub-categories or sub-types of information related to the selected pre-configured search filter 904. For example, the filter menu window 1002 in FIG. 10 is displayed in response to the selection of the “Pattern” pre-configured search filter 904. Filter menu window 1002 may include one or more pre-configured sub-filters 1004. A user may select one or more pre-configured sub-filters 1004, which causes a search to be narrowed according to the selected pre-configured sub-filter 1004. For example, a selection of the “Geometric” pre-configured sub-filter 1004 would cause a subsequent search to return only materials associated with a geometric pattern. A user may also unselect a selected pre-configured sub-filter 1004, thereby removing the search restriction accordingly.

In some examples, the selection of one or more pre-configured sub-filters 1004 automatically causes a corresponding search term to be entered into search bar 303. For example, a selection of the “Geometric” pre-configured sub-filter 1004 may cause the term “geometric” to be automatically entered into search bar 303. A user may also unselect a selected pre-configured sub-filter 1004, which automatically causes the removal of the corresponding search term from the search bar 303.

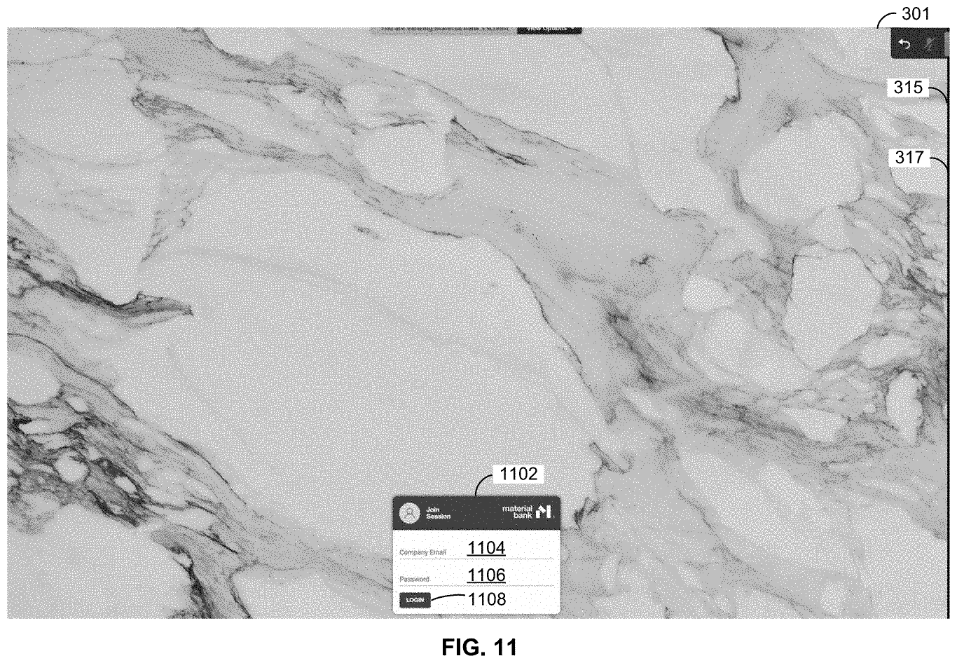

FIG. 11 illustrates a login window 1102 displayed over background image 317. Login window 1102 prompts a user to provide corresponding login credentials (e.g., a user name) such as email 1104 and corresponding authentication credentials such as password 1106. The user may provide the login and authentication credentials by selecting login icon 1108. In some examples, login window 1102 also allows a user to register for an account. For example, login window 1102 may include an icon for a “User Registration” which, if engaged by the user, causes the display of a registration window.

In some examples, a user must successfully login via login window 1102 to interact with electronic design palette 301. Once a user successfully logs in, a user may have access to one or more material boards associated with the user's account.

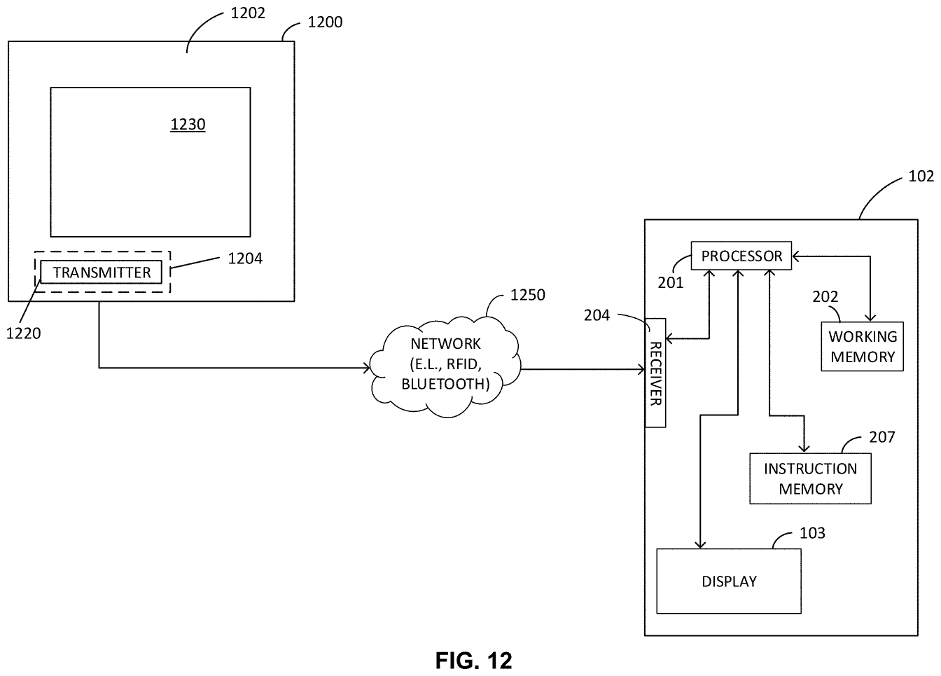

FIG. 12 shows the electronic design palette device 102 of FIG. 1 in communication with a swatch presentation device 1200. Swatch presentation device 1200 may allow for the display of a material, such as a swatch 1230. In this example, swatch presentation device 1200 includes a transmitter 1220 secured within a cavity 1204.

Transmitter 1220 may be, for example, an RFID tag, a Bluetooth transmitter, a transceiver, or any other suitable transmitting device. Transmitter 1220 may transmit data, such as data related to swatch presentation device 1200 or to swatch 1230, over network 1250. Network 1250 may be an RFID or Bluetooth® network, for example. In some examples, transmitter 1220 is configured to store and transmit data relating to swatch presentation device 1200 or swatch 1230 to electronic design palette device 102.

For example, transmitter 1220 may store and transmit a swatch identification (ID) that identifies swatch presentation device 1200. In some examples, transmitter 1220 may store and transmit swatch 1230 description information such as manufacture information, material information, color information, cleaning information, or any other information.

Although just one swatch presentation device 1200 is illustrated, electronic design palette device 102 is operable to receive data from a plurality of swatch presentation devices 1200 that include transmitters 1220. For example, electronic design palette device 102 may receive, over network 1250, data identifying a plurality of swatch presentation devices 1200, such as a swatch ID for each swatch presentation device 1200. Electronic design palette device 102 may determine information related to the identified swatch presentation device 1200 based on the received swatch ID. For example, computing device may determine description information for the swatch 1230 corresponding to the identified swatch presentation device 1200. Electronic design palette device 102 may cause the display of the determined information, such as description information, to display 103.

In some examples, electronic design palette device 102 accesses a database, such as database 116, to determine description information for the identified swatch presentation device 1200. The database may be a local database or a remote database, such as one located on a remote storage device, a cloud-based server, a memory device, a networked computer, or on any networked storage device. In some examples, the database includes a mapping of swatch presentation devices 1200 to swatches 1230, along with description information for each swatch 1230. Based on an obtained swatch ID received from a swatch presentation device 1200, electronic design palette device 102 accesses database 116 to determine the corresponding swatch 1230 being presented by the identified swatch presentation device 1200. Electronic design palette device 102 may also access database 116 to determine description information corresponding to the determined swatch 1230.

In some examples, swatch presentation device 1200 may be the swatch presentation device as described in U.S. Provisional Application No. 62/837284.

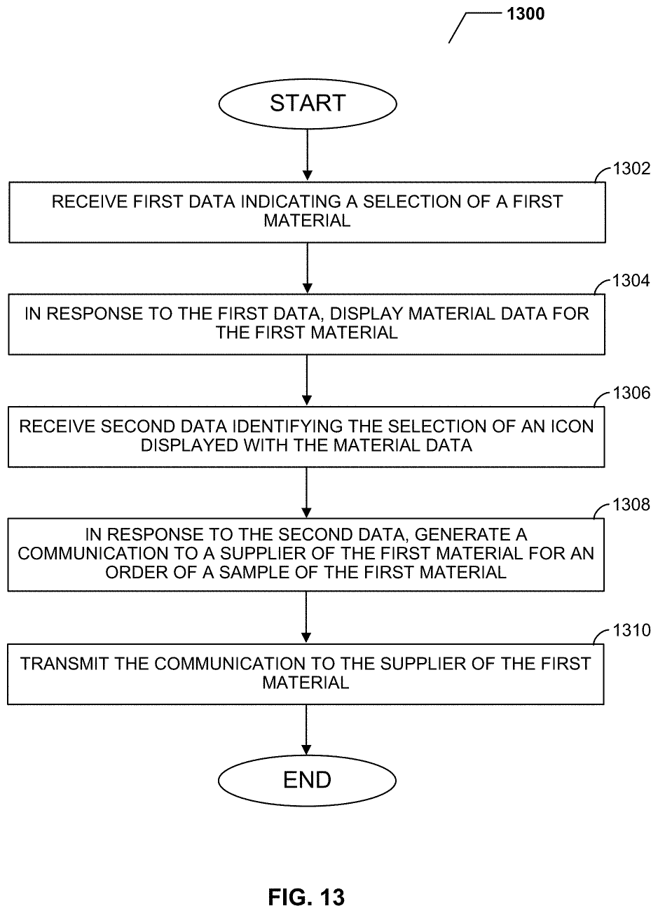

FIG. 13 illustrates a flowchart of an example method 1300 that may be carried out by, for example, the electronic design palette device 102 of FIG. 1. Beginning at step 1302, first data is received indicating a selection of a first material. For example, electronic design palette device 102 may detect the selection of a material image (e.g., material image 323) via a touchscreen sensitive display 103. At step 1304, material data for the first material is displayed in response to receiving the first data. For example, electronic design palette device 102 may display material data, such as material swatch 370, in response to detecting the selection of the material image. Proceeding to step 1304, second data is received. The second data identifies the selection of an icon displayed with the material data. For example, electronic design palette device 102 may detect the selection of an icon displayed over material swatches 370, such as add-to-order icon 412 to order samples of the material.

At step 1308, in response to receiving the second data, a communication, such as an email or SMS message, is generated. The communication is generated to a supplier for an order of a sample of the first material. For example, the communication may be an email destined to the supplier of the first material (e.g., to the supplier's email address), requesting a sample of the first material. In some examples, the communication may be an SMS message (e.g., text message) destined to a cellular phone number of the supplier, requesting a sample of the first material. In some examples, the communication includes the address to ship the sample to, which may include the customer's address. At step 1310, the communication is transmitted. For example, the communication is transmitted to the supplier of the first material. In some examples, the communication is also transmitted to the customer. The method then ends.

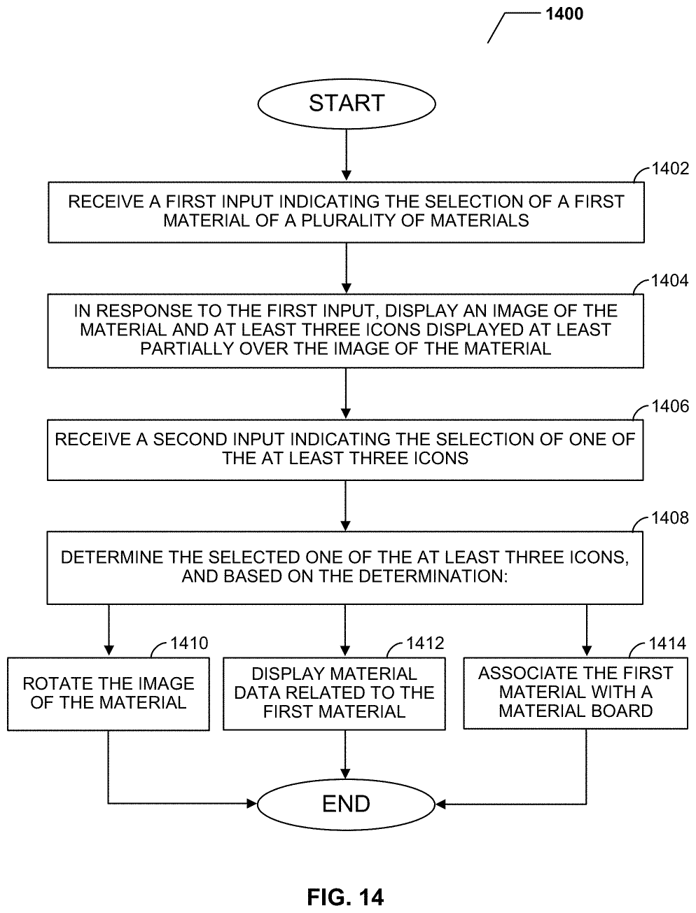

FIG. 14 illustrates a flowchart of another example method 1400 that may be carried out by, for example, the electronic design palette device 102 of FIG. 1. Beginning at step 1402, a first input is received indicating the selection of a first material of a plurality of materials. For example, electronic design palette device 102 may detect the selection of a material image within material display area 320 of touchscreen sensitive display 103. Proceeding to step 1404, in response to the first input, an image of the material is displayed, as well as at least three icons each displayed at least partially over the image of the material. For example, electronic design palette device 102 may display material display 402, which includes a display of the material, and may include an icon to rotate material display 402, an icon to display data related to the material of material display 402, and an icon to associate material display 402 with a material board.

The method then proceeds to step 1406, where a second input is received indicating the selection of the at least three icons. At step 1408, the selected icon is determined and, based on the determination, the method may proceed to either step 1410, 1412, or 1414. If the selected icon is associated with rotating the image of the material, the method proceeds to step 1410 where the image of the material is rotated (e.g., clockwise, or counter-clockwise). If instead the selected icon is associated with displaying data related to the material, the method proceeds to step 1412 where material data related to the first material is displayed. If the selected icon is associated with associating the first material with a material board, the method proceeds to step 1414, where the first material is associated with a material board. For example, the first material may be associated with a currently selected (e.g., active) material board. The method then ends.

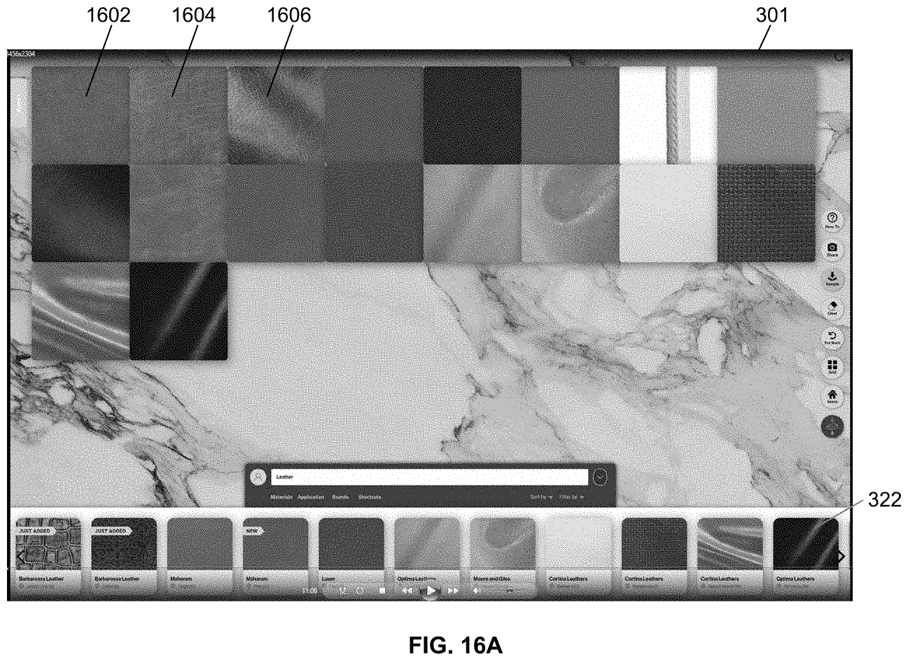

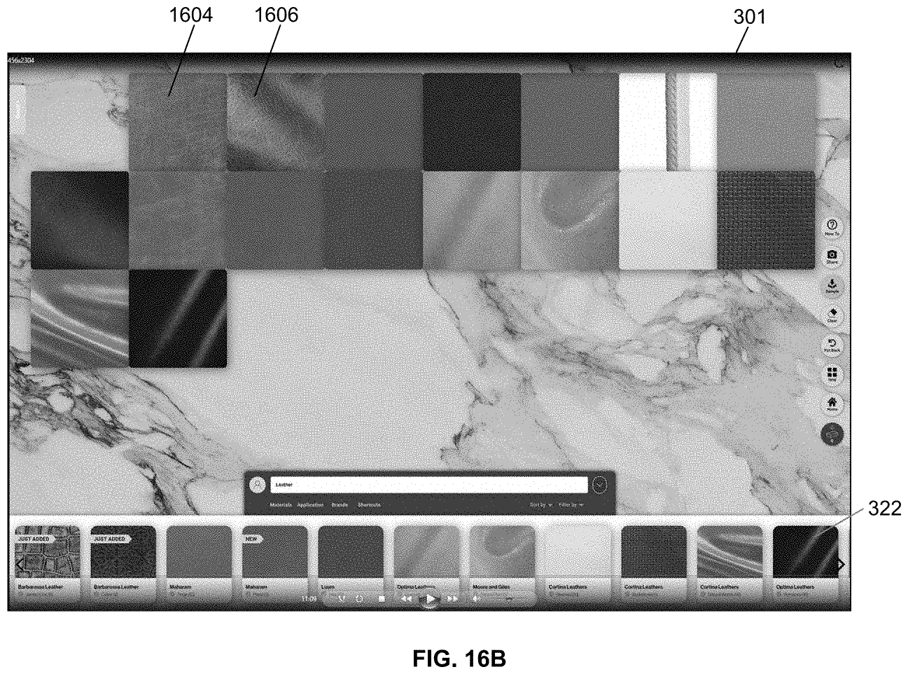

FIG. 16A illustrates a plurality of sorted material swatches, such as material swatches 1602, 1604, 1606, displayed within electronic design palette 301. In this example, the plurality of material swatches are sorted according to an order they were added to electronic design palette 301. For example, a user may have first added (e.g., by double clicking a material sample 322) a first material swatch 1602 to electronic design palette 301, which is displayed on a top-left corner of electronic design palette 301. The user may then have added a second material swatch 1604, which is displayed next to first material swatch 1602 (e.g., in a same row as, and adjacent to, first material swatch 1602). A user may then have added a third material swatch 1606, which is displayed next to second material swatch 1604. As a user selects material samples 322, corresponding material swatches can be added to electronic design palette 301 in a predetermined order. For example, the material swatches can be added to the electronic design palette 301 in a top-left to bottom-right configuration (e.g., starting from a top row, adding material swatches in the row from left to right, and beginning from a next row when there is not enough display area left for another material swatch in the top row).

FIG. 16B illustrates the removal of material swatches displayed within electronic design palette 301. For example, a user may remove a material swatch 1602, 1604, 1606 by “swiping” (e.g., flicking with a finger or stylus) the material swatch off of electronic design palette 301. In some examples, the swiping motion may be towards an edge 1610 of electronic design palette 301. In this example, a user has swiped first material swatch 1602 towards the top edge of electronic design palette 301, and thus no longer appears within electronic design palette 301.

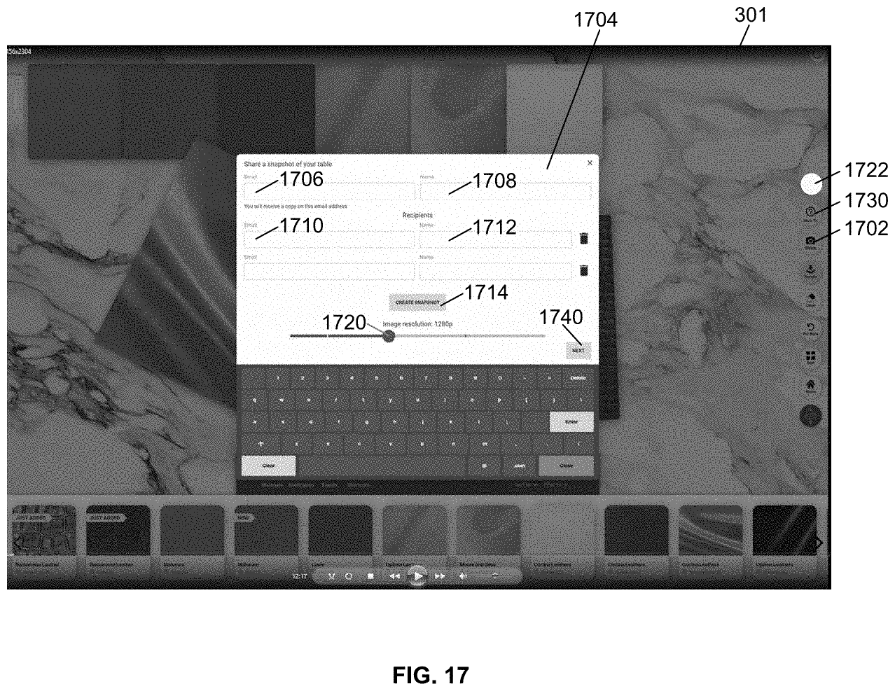

In some examples, electronic design palette device 102 may include functionality to have an image (e.g., screenshot) taken of the electronic design palette 301, and have the image transmitted. For instance, the image may be transmitted via e-mail or SMS message. As illustrated in FIG. 17, electronic design palette 301 includes a camera icon 1702 that, when engaged by a user, causes a share menu 1704 to display within a portion of the electronic design palette 301. Share menu 1704 may include various fields, such as a user email field 1706 where a user may enter the user's email address, and a user name 1708 where a user may enter their name. Share menu 1704 may further include one or more fields for recipient email addresses 1710 and one or more fields for corresponding recipient names 1712. Share menu may further include a create snapshot icon 1714 which, upon engagement by the user, causes an image (e.g., snapshot) to be taken of electronic design palette 301. In some examples, the image may include only the table portion 315 of the electronic design palette 301. For example, the image would not include the material sample portion 320 of the electronic design palette 301. In some examples, the image would not include any icons, or share menu 1704. The image may be captured according to a resolution selected by the user using resolution selection interface 1720, which in some examples may be a slider that can be set to one of a number of preconfigured resolution settings. Upon engagement of submit icon 1740, the electronic design palette device 102 transmits the captured image to the recipient email addresses 1710.

In some examples, the electronic design palette 301 may include a poster icon 1722, which allows for the mailing of a poster of electronic design palette 301. For example, upon a user engaging poster icon 1722, a poster menu may be displayed over a portion of electronic design palette 301. The poster menu can include the same general fields as the share menu, such as fields for a name, mailing address, and phone number of a recipient. In addition, the poster menu may include a snapshot icon, similar to snapshot icon 1714, which allows an image to be taken of at least a portion of electronic design palette 301. The poster menu may further include a “submit” icon (e.g., similar to submit icon 1740) which, upon engagement, causes a communication (e.g., email or SMS) to be transmitted to, for example, an operator of electronic design palette device 102. In some examples, the communication may be transmitted to a third-party that may facilitate the mailing of the poster to the recipient. The communication may include the image, as well as all or a portion of contact information entered within the various fields of the poster menu.

FIG. 17 further illustrates a “how to” icon 1730. Upon engagement of “how to” icon 1730, electronic design palette device 102 causes a display of various links or menus for one or more features of electronic design palette 301. For example, in response to a selection of “how to” icon 1730, electronic design palette device 102 may cause a display of a link for each of a plurality of features, where each link may cause a pop-up window with information regarding the corresponding feature. In some examples, each link includes text corresponding to the feature. Merely as an example, one link may, if engaged, display information related to how to add a material swatch to, or remove a material swatch from, electronic design palette 301. Other links and or menus may include information on how a user may cause electronic design palette device 102 to execute other features as well.

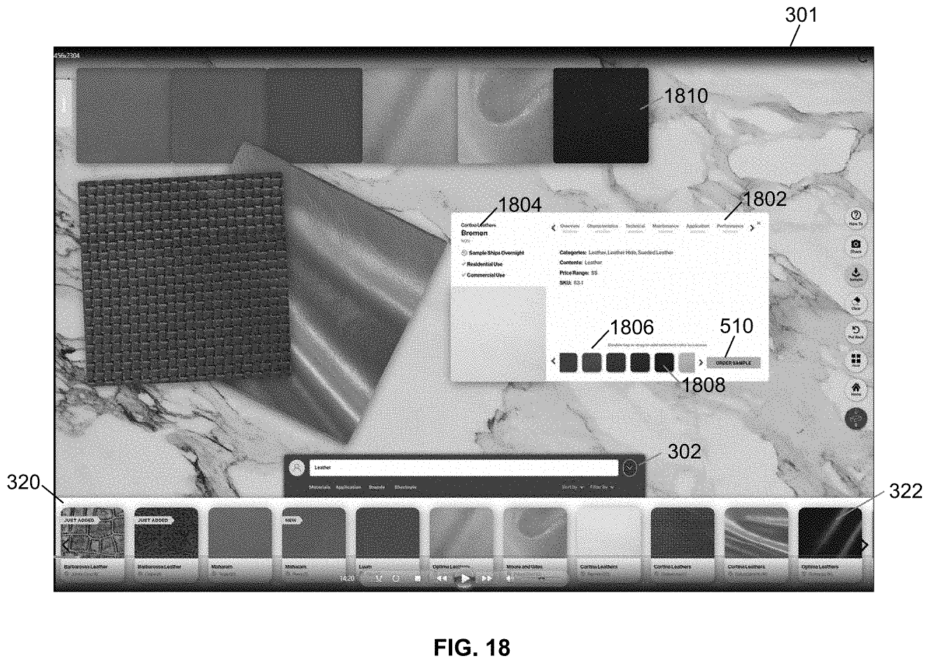

FIG. 18 illustrates an information menu 1802 for an item 1804 that includes selectable color options 1806 (e.g., various “colorways”), a material image 1808, and order sample icon 510. In some examples, a user may add to electronic design palette 301 a material swatch for item 1804 based on an engagement of one of color options 1806. For example, a user may engage (e.g., double click) a color option 1808 and, in response, electronic design palette device 102 may cause material swatch 1810 to be displayed within electronic design palette 301. In some examples, a user may drag a color option 1806 to electronic design palette 301.

In some examples, search window 302 may include an option to allow a user to select whether material samples 322 (e.g., search results) displayed within material sample portion 320 are to include items 1804 in the various color options 1806. For example, a user may enable an option that will cause material samples 322 to display material images 1808 in all color options 1806 for each item 1804 that is returned in response to a search request a user enters into search bar 303.

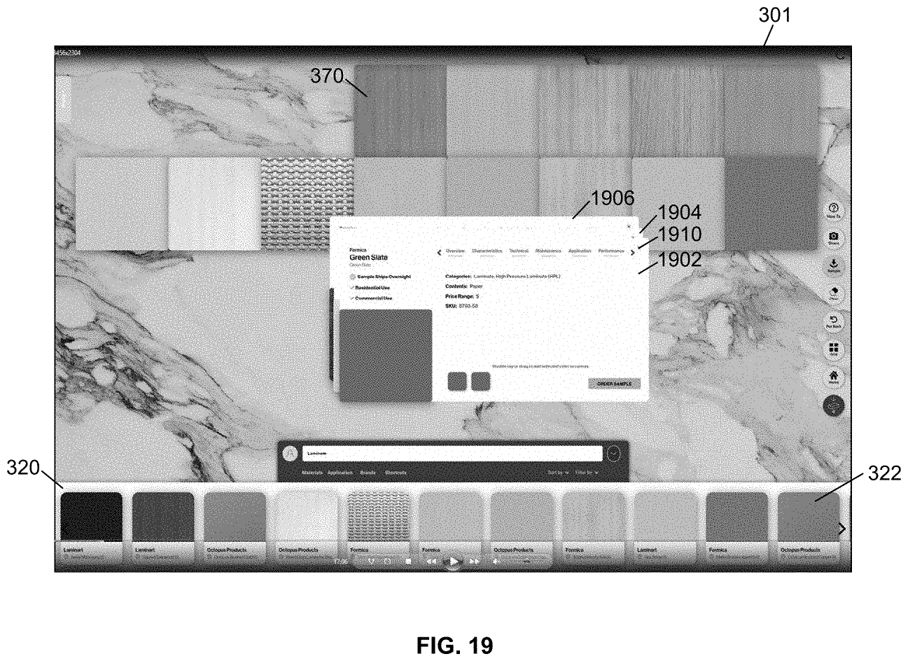

In some examples, electronic design palette device 102 may cascade information menus 1902, 1904, 1906 as a user engages (e.g., double clicks) a plurality of material swatches 370. For example, FIG. 19 illustrates a first information menu 1902 cascaded over a second information menu 1904. Further, the second information menu is cascaded over a third information menu 1906. In some examples, the information menus 1902, 1904, 1906 are cascaded over a center portion of electronic design palette 301. As a user engages each material swatch 370, electronic design palette device 102 may cause the material swatch to be removed from electronic design palette 301.

In some examples, each information menu 1902, 1904, 1906 may include an exit icon 1910. Upon a user engaging exit icon 1910, electronic design palette device 102 may cause the information menu 1902, 1904, 1906 corresponding to the selected exit icon 1910 to be removed from electronic design palette 301. In some examples, electronic design palette device 102 further causes the corresponding material swatch 370 to be displayed within electronic design palette 301. For example, electronic design palette device 102 may cause the corresponding material swatch 370 to reappear in its previous position (e.g., before being removed from electronic design palette 301 upon being engaged by the user).

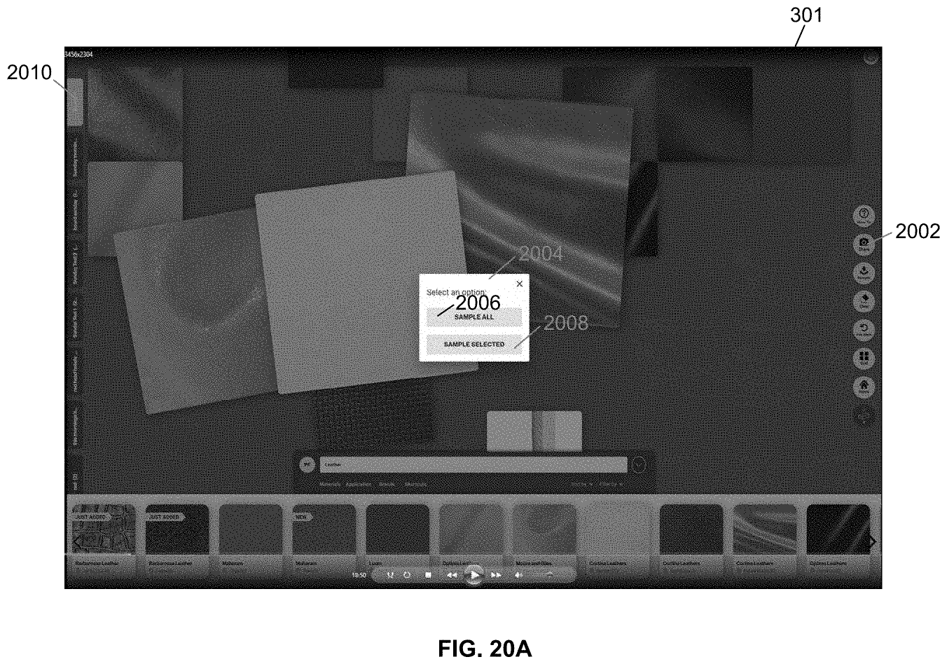

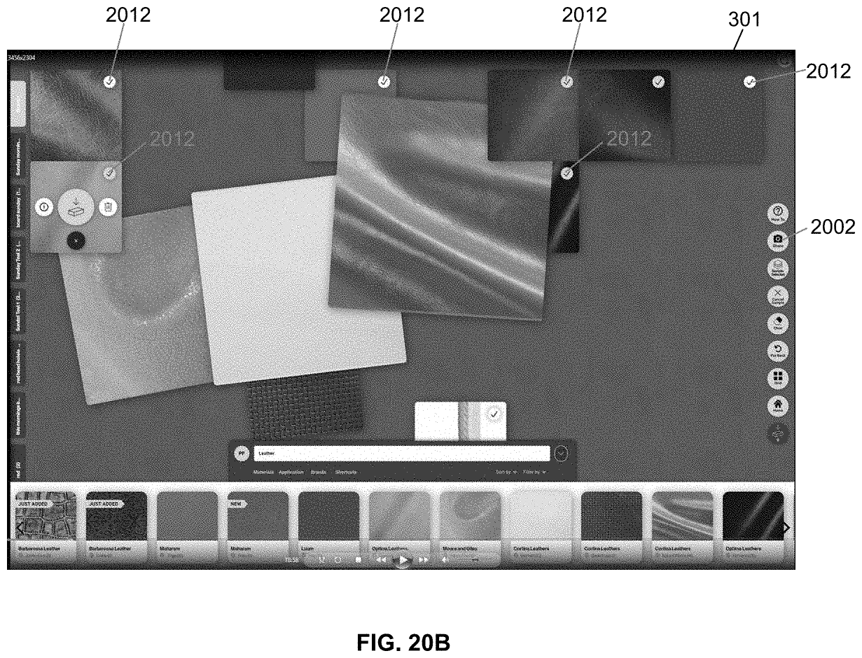

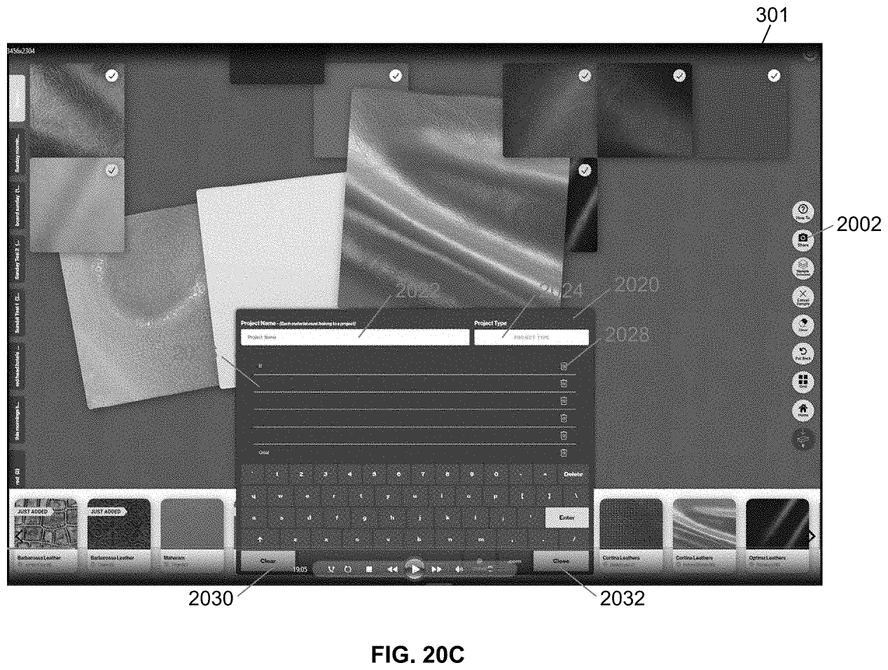

FIG. 20A illustrates a sample icon 2002 that, if engaged by a user, causes sample menu 2004 to be displayed within electronic design palette 301. Sample menu 2004 may include a sample all option 2006 and a sample selection option 2008. Engagement of the sample all option 2006 may cause electronic design palette device 102 to select all material swatches 370 that are part of a selected board 2010 (e.g. active board). Further, engagement of the sample all option 2006 may also cause electronic design palette device 102 to transmit a communication, such as an email or SMS (e.g., text) message, to order samples of all of the selected items as described above (e.g., such as when engaging send samples icon 560).

Engagement of the sample selection option 2008, however, causes electronic design palette device 102 to display a selection icon 2012 for each displayed material swatches 370, as illustrated in FIG. 20B. A user may engage selection icon 2012 to select, or deselect, each of the material swatches 370. Upon re-engaging the sample icon 2002, electronic design palette device 102 may cause electronic design palette device 102 to transmit a communication, such as an email or SMS (e.g., text) message, to order samples of the selected items as described above.

Further, a user may create a new board with currently selected material swatches 370. Referring to FIG. 20C, a user may add a new board by engaging an add board icon which, when engaged, causes the display of add board menu 2020. Add board menu 202 may include various fields such as a project name field 2022, a project type field 2024, as well as a material field 2026 that identifies all materials for the new board. A remove icon 2028 allows a user to individually remove materials from being added to the new board. A clear icon 2030 allows a user to move all materials currently listed with material field 2026. Further, close icon 2032 allows a user to add all materials currently listed with material field 2026 to the new board identified by a name identified within project name field 2022.

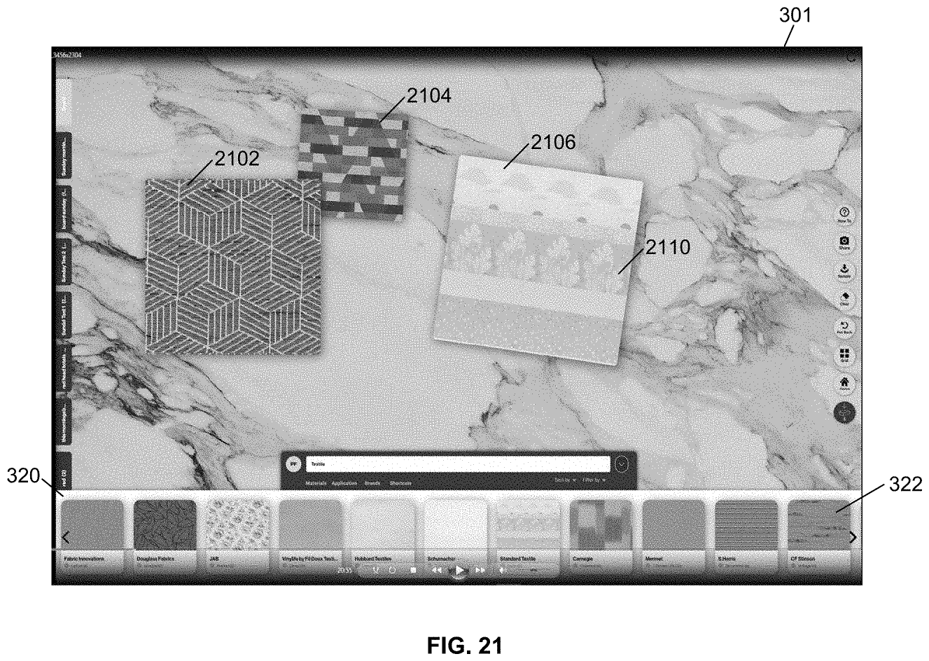

FIG. 21 illustrates a first material swatch 2102, a second material swatch 2104, and a third material swatch 2106. In some examples, electronic design palette 301 includes an image scale icon that causes electronic design palette device 102 to display each of first material swatch 2102, second material swatch 2104, and third material swatch 2106 in accordance with actual sizes of the materials (e.g., material design). For example, database 116 may store data identifying dimensions of the design of each material swatch 2102, 2104, 2106. As an example, a leaf 2110 of third material swatch 2106 may be 3 inches tall in the actual material. Upon selecting the image scale icon, electronic design palette device 102 causes third material swatch 2106 to display in accordance with actual dimensions of the design (e.g., to scale), including displaying a 3 inch tall leaf. In some examples, database 116 stores dimension data (e.g., ratios) based on actual dimensions of each material corresponding to each material swatch. Upon engagement of the image scale icon, electronic design palette device 102 determines an image scale size for each material swatch 2102, 2104, 2106 based on a current size of each material swatch 2102, 2104, 2106, and the corresponding dimension data for each material swatch 2102, 2104, 2106. Based on the determined image scale sizes, electronic design palette device 102 redisplays each of material swatch 2102, 2104, 2106 in accordance with the actual dimensions of each of their designs.

In some examples, a user may increase, or decrease the size of each material swatch 2102, 2104, 2106 without changing the dimensions of the included designs. For example, a user may drag an edge of third material swatch 2106 toward its middle to decrease its size. As the size of third material swatch 2106 decreases, the size of the included design (e.g., the 3 inch leaf) remains the same. For example, as the size of third material swatch 2106 decreases, less and less of the design may be viewable. Similarly, if a user increases the size of third material swatch 2106, more and more of the design may become viewable, although the dimensions of the design do not change.

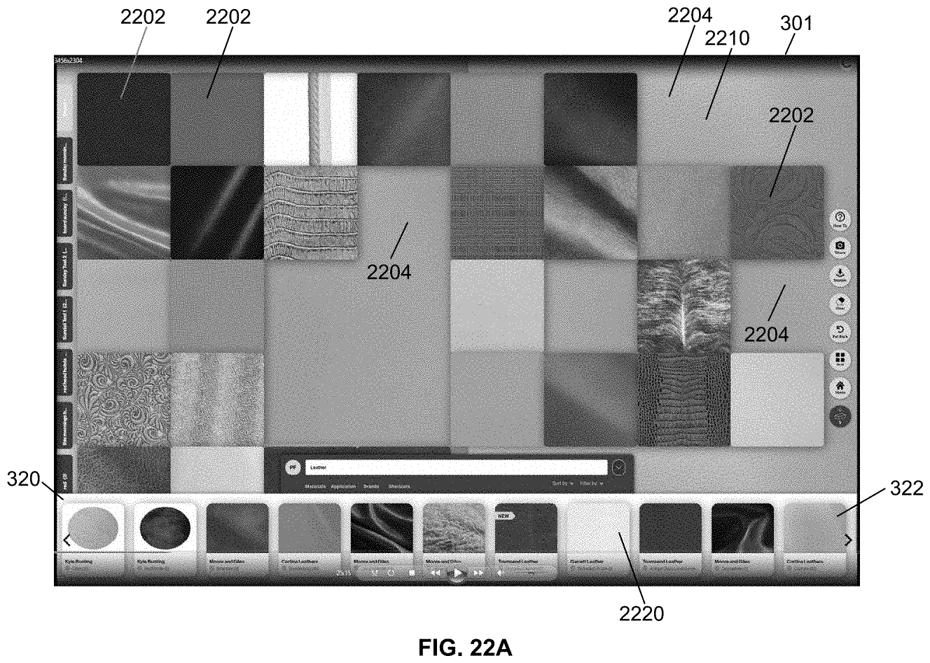

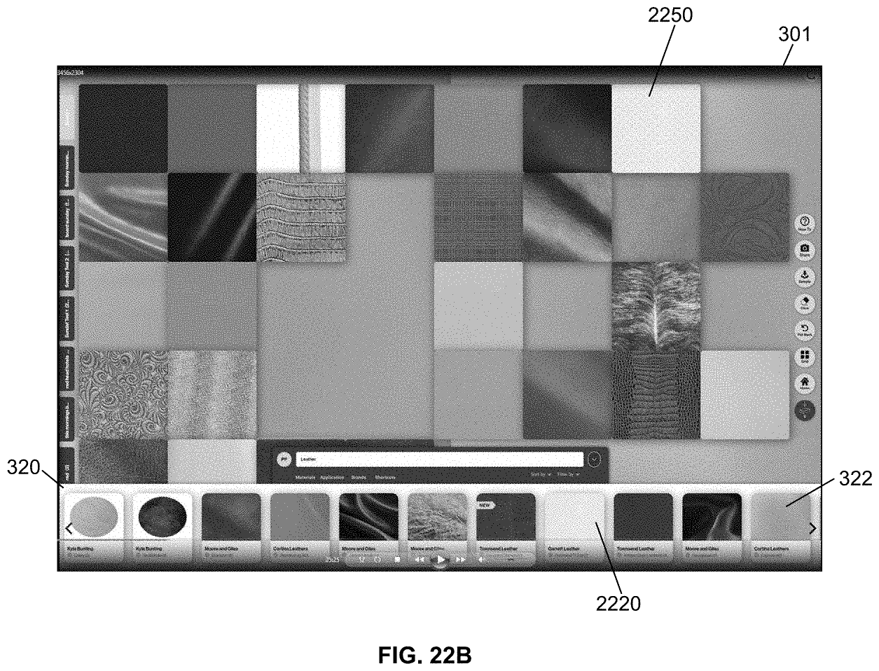

FIG. 22A illustrates an electronic design palette 301 that includes material samples 322 displayed within material sample portion 320. FIG. 22A further illustrates a plurality of material swatches 2202, and portions 2204 of electronic design palette 301 that display the background image 317. In some examples, a user may engage (e.g., double click) one or more of the material samples 322 and, in response, electronic design palette device 102 causes the engaged material sample 322 to appear within a portion 2204. In some examples, electronic design palette device 102 causes the engaged material sample 322 to appear within the first available portion 2204 (e.g., in a top-to-bottom, left-to-right, configuration). For example, first empty portion 2210 is currently not displaying a material sample. If a user were to engage, for example, material sample 2220, electronic design palette device 102 may cause a material swatch 2250 corresponding to material sample 2220 to appear within first empty portion 2210, as illustrated in FIG. 22B.

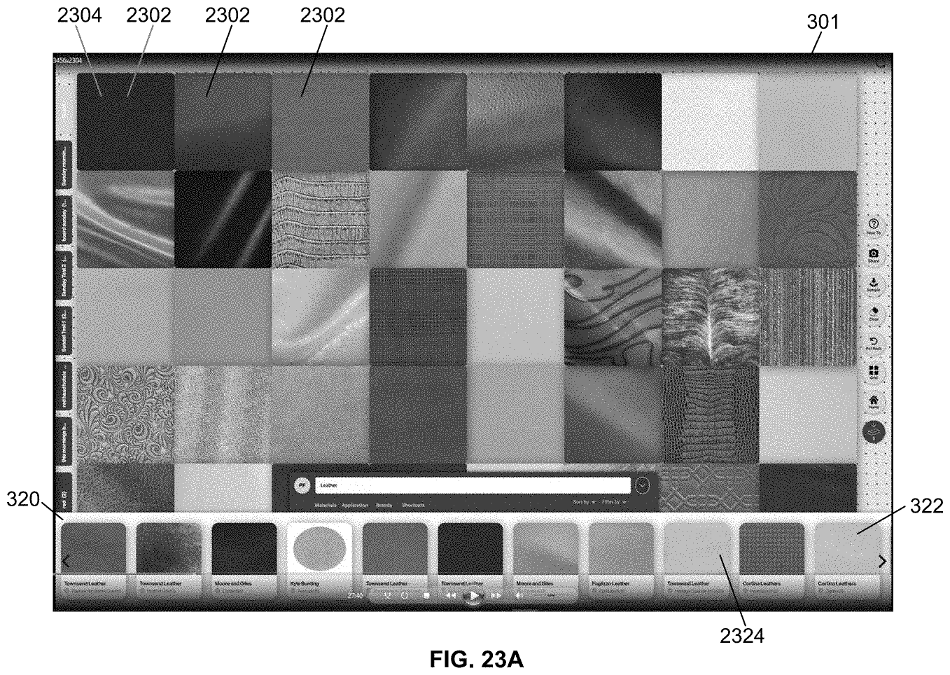

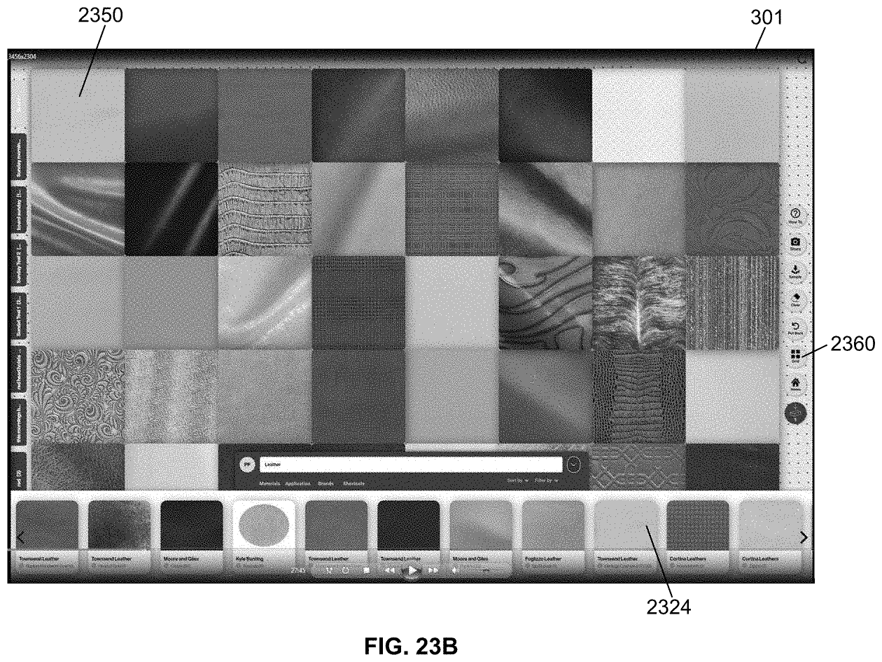

If electronic design palette 301 includes no empty portions (e.g., material swatches take up all available display space), electronic design palette device 102 may stack a material swatch on top of an existing material swatch. For example, electronic design palette device 102 may stack material swatches on top of other material swatches in a top-to-bottom, left-to-right, configuration. For example, FIG. 23A illustrates an electronic design palette 301 with a plurality of material swatches 2302, including a first material swatch 2304. If a user were to engage, for example, material sample 2324, electronic design palette device 102 may stack a new material swatch 2350 (corresponding to material sample 2324) to appear over first material swatch 2304, as illustrated in FIG. 23B.

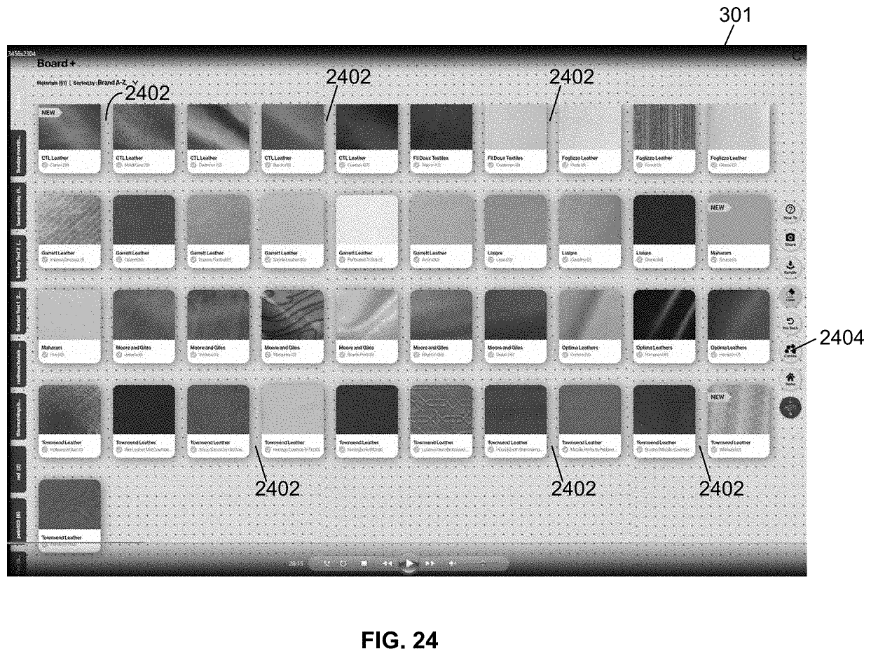

FIG. 23B further illustrates a grid mode icon 2360. Grid mode icon 2360, if engaged by a user, causes electronic design palette 301 to be displayed in a grid mode, as illustrated in FIG. 24. In grid mode, a user may scroll vertically and/or horizontally by, for example, “dragging” electronic design palette 301 in a direction. A user may drag electronic design palette 301 by, for example, holding down two fingers on user interface 205, and dragging user interface 205 in a direction. For example, a user may scroll down by dragging electronic design palette 301 up. Similarly, a user may scroll up by dragging electronic design palette 301 down. In grid mode, electronic design palette 301 may include a spacing 2402 between displayed material swatches. Once in grid mode, rather than display grid icon 2360, electronic design palette 301 may display a canvas icon 2404 that, if engaged by the user, causes electronic design palette device 102 to display electronic design palette 301 as illustrated in FIG. 23B.

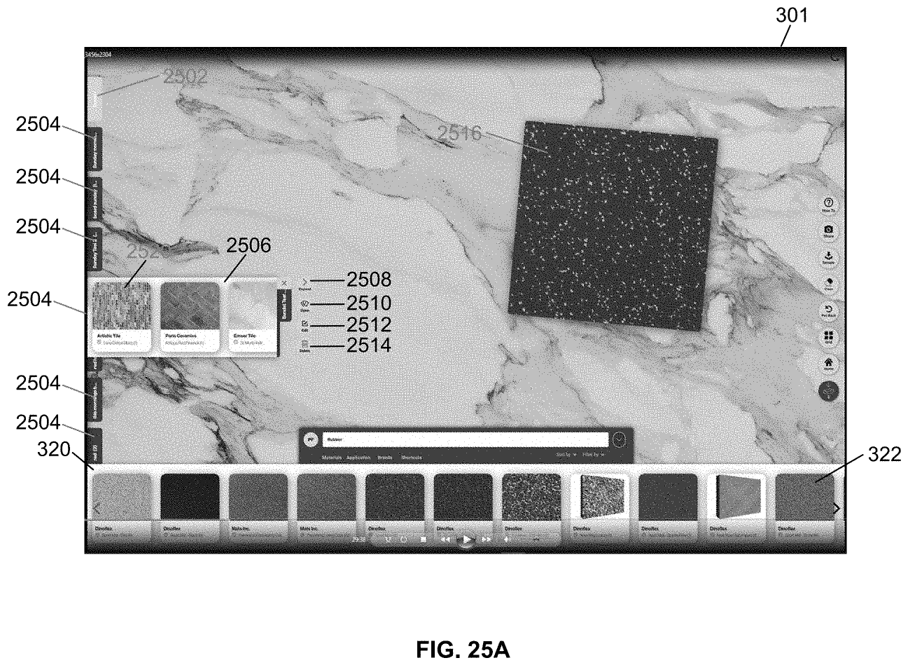

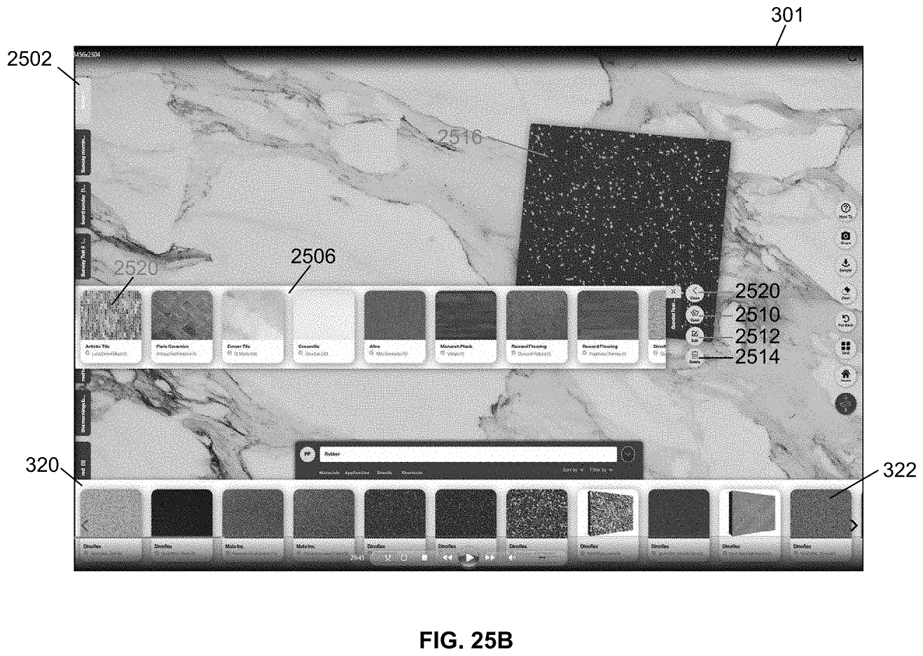

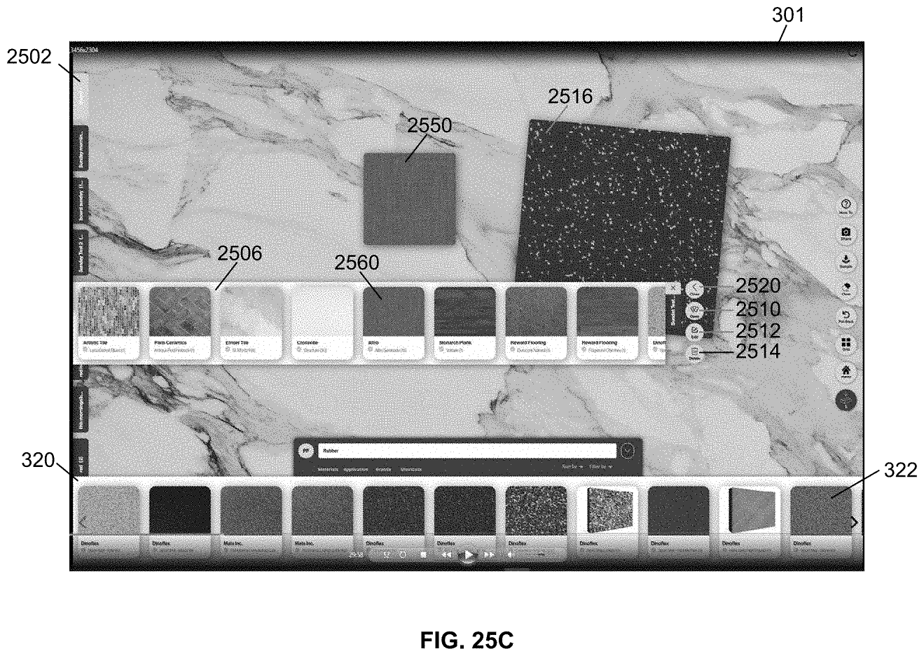

FIG. 25A illustrates an active board tab 2502 for the currently active board, as well as a plurality of inactive board tabs 2504. Selection of a board tab causes the display of electronic design palette 301 associated with the selected board tab. For example, material swatch 2516 is associated with the current board, as selected by the active board tab 2502. A user may cause an inactive board to become the active board by engaging an inactive board tab. For example, a user may cause a switch from a current board to an inactive board by double clicking an inactive board tab 2504. In some examples, a user may engage an inactive board tab 2504 and, in response, electronic design palette device 102 may display an options menu 2506 for the corresponding inactive board. Options menu 2506 may include, for example, one or more material samples 2520, an expand icon 2508, an open icon 2510, an edit icon 2512, and a delete icon 2514. Material samples 2520 may correspond to material swatches 370 that are part of the corresponding inactive board.

Engagement of expand icon 2508 may cause options menu 2506 to expand, as illustrated in FIG. 25B. For example, engagement of expand icon 2508 may cause additional material samples 2520 associated with the inactive board to be displayed. Engagement of the open icon 2510 may cause electronic design palette device 102 to switch the inactive board from being inactive to become the active board. The active board may then become inactive, and an inactive board tab 2504 may be displayed for the previously active board. Engagement of the edit icon 2512 may allow a user to edit properties of the corresponding inactive board, such as change the name of the inactive board. In some examples, engagement of the edit icon 2512 may allow a user to add, or remove, material swatches 370 from the inactive board.

Further, a user may be able to add material swatches 370 from an active board to an inactive board. For example, a user may drag material swatch 2516 to options menu 2506 to add material swatch 2516 to the inactive board. As such, if a user activates the inactive board (e.g., by double clicking the corresponding inactive board tab 2504), material swatch 2516 would be included in electronic design palette 301 for the inactive board. Similarly, and as illustrated in FIG. 25C, a user may drag a material sample 2550 from options menu 2506 onto the electronic design palette 301 of the active board and, in response the material swatch 2560 corresponding to the material sample 2550 is added to the currently active board.

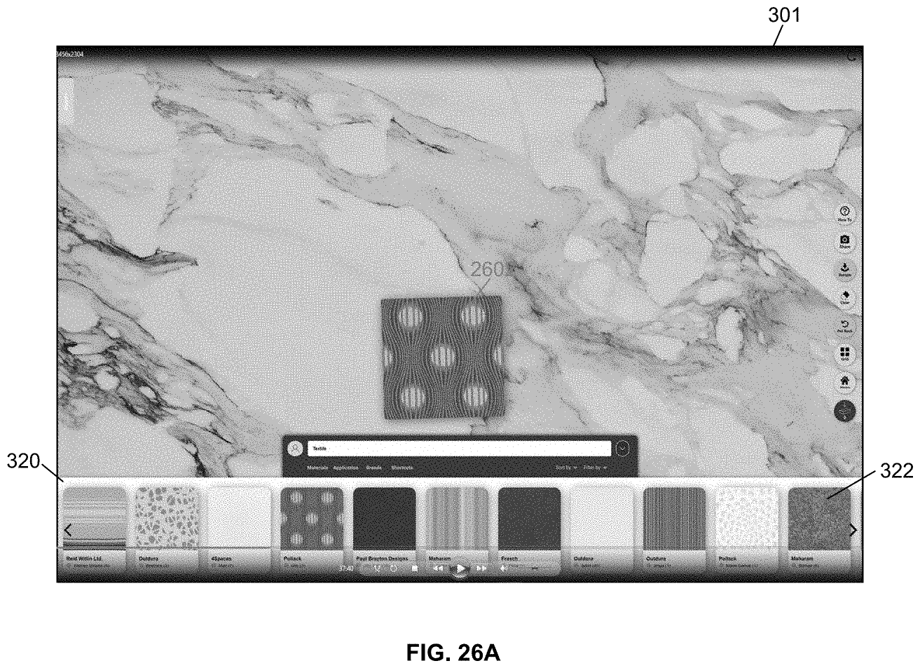

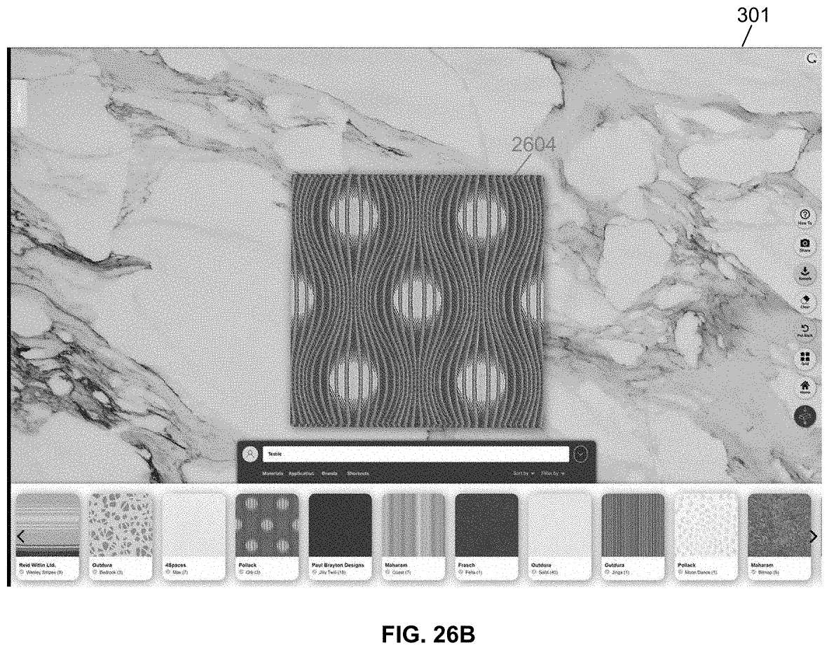

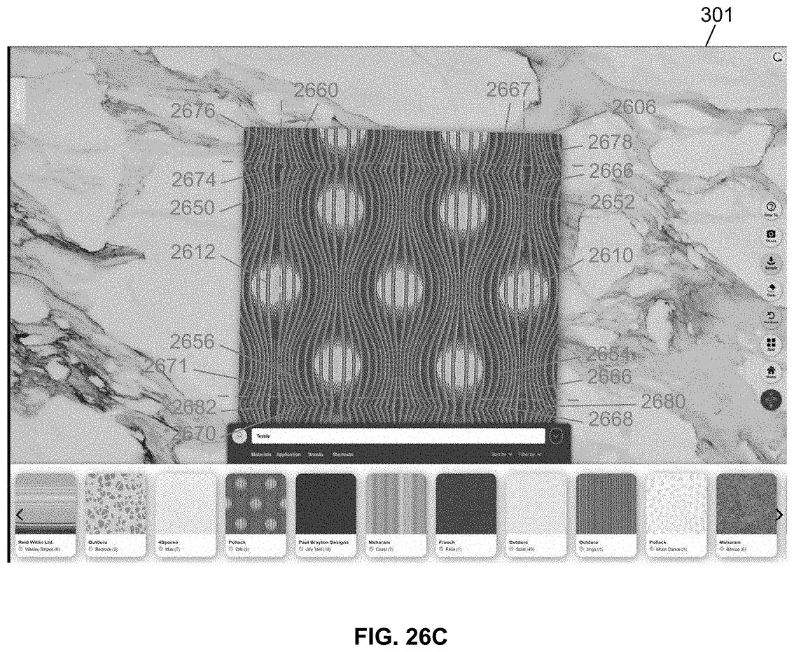

In some examples, a user may change the size of a material swatch. For example, FIG. 26A illustrates a material swatch 2602 displayed within electronic design palette 301. A user may enlarge, or reduce, a size of material swatch 2602 by dragging (e.g., holding down and sliding) an edge of material swatch 2602. For example, a user may drag a top edge of material swatch 2602 towards a center of material swatch 2602 to reduce the size of material swatch 2602. To reduce the size of the material swatch 2602, electronic design palette device 102 may rescale the material swatch 2602 based on the dimensions of the resized edges of the material swatch 2602. For example, electronic design palette device 102 may reduce the spatial resolution of material swatch 2602 while keeping its same two-dimensional representation (e.g., downsample material swatch 2602). Similarly a user may drag the top edge of material swatch 2602 away from the center of material swatch 2602 to increase the size of material swatch 2602. For example, FIG. 26B displays an enlarged material swatch 2604.

In some examples, a material swatch 2602 may be enlarged up to a maximum resolution. For example, assuming the material swatch 2602 was captured at a resolution of 4200 pixels by 2800 pixels, electronic design palette device 102 may, in response to an input by a user to enlarge material swatch 2602, enlarge material swatch 2602 up to 4200 pixels by 2800 pixels. If the user attempts to enlarge material swatch 2602 further, electronic design palette device 102 causes material swatch 2606 to tile, as illustrated in FIG. 26C. For example, electronic design palette device 102 may cause the display of additional portions of material swatch 2602 to extend (e.g., repeat), as illustrated by the tiled material swatch 2606. For example, design areas 2610, 2612 include portions that do not appear in material swatch 2602.

In some examples, to tile material swatch 2606, electronic design palette device 102 may repeat portions of material swatch 2606. For example, material swatch 2606 includes first area 2650, second area 2652, third area 2654, and fourth area 2656. FIG. 26C further illustrates dashed lines. The areas inside of the dashed lines identify the maximum sized material swatch (e.g., material swatch 2604 of FIG. 26B), and the areas outside of the dashed lines are areas electronic design palette device 102 generates by tiling.

For example, electronic design palette device 102 may generate first tiled area 2660 by repeating fourth area 2656. Similarly, electronic design palette device 102 may generate: second tiled area 2662 by repeating second area 2652; third tiled area 2664 by repeating first area 2650; fourth tiled area 2666 by repeating fourth area 2656; fifth tiled area 2668 by repeating second area 2652; sixth tiled area 2670 by repeating first area 2650; seventh tiled area 2672 by repeating third area 2654; and eight tiled area 2674 by repeating second area 2652. Likewise, electronic design palette device 102 may generate ninth tiled area 2676 by repeating third area 2654, and may generate tenth tiled area 2678 by repeating fourth area 2656. Electronic design palette device 102 may also generate eleventh tiled area 2680 by repeating first area 2650, and may generate twelfth tiled area 2682 by repeating second area 2652.

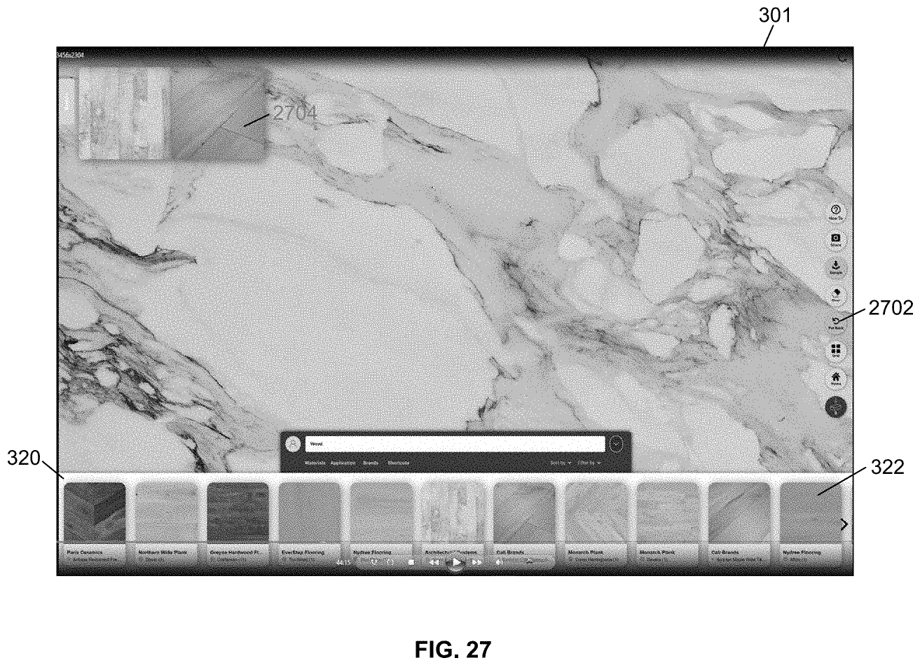

FIG. 27 illustrates a put back icon 2702 displayed within electronic design palette 301 which, if engaged, allows a previous action to be undone. For example, a user may add a material swatch 2704 to the current board as explained herein. If a user decides to undo the addition of material swatch 2704, the user may engage the put back icon 2702. A user may engage the put back icon 2702 any number of times, and a corresponding number of previous actions will be undone. In some examples, electronic design palette 301 includes a redo icon which, if engaged, undoes the action of put back icon 2702. For example, if a sample has been removed from the electronic design palette 301, the redo icon may allow a user to redo an action undone by having engaged the put back icon 2702.

As noted above, electronic design palette 301 may include a filter menu 902 that allows a user to select one or more pre-configured filters during a search. For example, by selecting a pre-configured filter, electronic design palette device 102 conducts a search of materials based on the pre-configured filter, such as by searching database 116 for material samples 322 based on one or more search terms associated with the pre-configured filter. In some examples, electronic design palette 301 includes “dynamic” filters such that the filters displayed are based on the results of the search request.

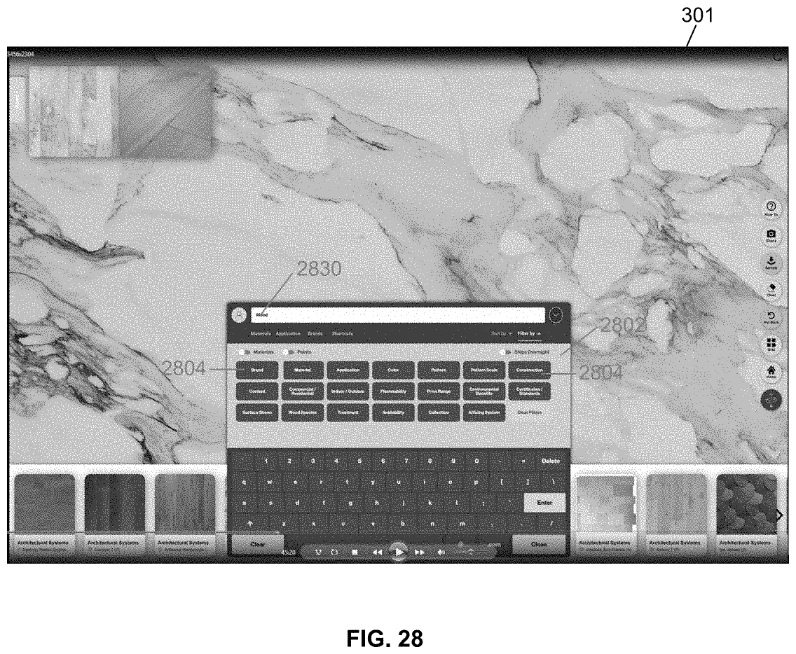

For example, FIG. 28 illustrates a filter menu 2802 that includes a plurality of filters 2804. In this example, because the search term 2830 is “wood,” only materials with a wood aspect may be returned in the search results (e.g., the material samples 322 displayed within material sample portion 320). The plurality of filters 2804 displayed are based on features of the search results. For example, unless at least one material sample 322 has a particular feature, a filter for that feature will not be displayed (e.g., the filter would not be provided as an option). In this example, at least one search result (e.g., material sample 322) has a feature that can be identified (e.g., filtered for) by each one of the plurality of filters 2804. In some examples, electronic design palette device 102 compares the features of each of the search results to each possible filter (e.g., filter possibilities) to determine if the filter should be displayed.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A apparatus comprising:
a communications unit;
a memory device storing instructions; and
at least one processor operatively coupled to the communications unit and the memory device, wherein the at least one processor is configured to execute the instructions to:
generate for display a plurality of material swatch images, wherein each material swatch image is associated with a material;
receive a first input identifying a selection of at least one material swatch image of the plurality of material swatch images;
associate the at least one material swatch image with a material board based on receiving the first input;
receive a second input;
in response to the second input, automatically generate a communication for a sample of the material associated with the at least one material swatch image; and
transmit, via the communications unit, the communication.

2. The apparatus of claim 1, wherein the at least one processor is configured to execute the instructions to:
receive a third input; and
in response to receiving the third input, adjust a size of the at least one material swatch image.

3. The apparatus of claim 2, wherein adjusting the size of the at least one material swatch image comprises adjusting the at least one material swatch image to a size of a material sample corresponding to the at least one material swatch image.

4. The apparatus of claim 2, wherein adjusting the size of the at least one material swatch image comprises enlarging the at least one material swatch image to a maximum resolution.

5. The apparatus of claim 4, wherein the at least one processor is configured to execute the instructions to:
receive a fourth input; and
in response to receiving the fourth input, tiling the at least one material swatch image to enlarge the at least one material swatch image past the maximum resolution.

6. The apparatus of claim 1, wherein the at least one processor is configured to execute the instructions to:
receive a third input; and
in response to receiving the third input, rotate the at least one material swatch image.

7. The apparatus of claim 1, wherein the at least one processor is configured to execute the instructions to:
receive a third input; and
in response to receiving the third input, generate for display an information menu for the at least one material swatch image.

8. The apparatus of claim 7, wherein the information menu identifies options for the material associated with the at least one material swatch image.

9. The apparatus of claim 1, wherein the at least one processor is configured to execute the instructions to:
receive a third input; and
in response to receiving the third input, generate for display a window identifying a plurality of material boards associated with a user's account.

10. The apparatus of claim 1, wherein the at least one processor is configured to execute the instructions to:
receive a third input; and
in response to receiving the third input, display the plurality of material swatch images in a predetermined order.

11. The apparatus of claim 10, wherein the at least one processor is configured to execute the instructions to:
receive a fourth input;
in response to receiving the fourth input, removing from display at least one of the plurality of material swatch images from a first location;
receive a fifth input; and
in response to receiving the fifth input, displaying an additional material swatch image at the first location.

12. The apparatus of claim 1, wherein the at least one processor is configured to execute the instructions to:
receive a third input;
display at plurality of filters;
receive a selection of at least one of the plurality of filters; and
generate for display a subset of the plurality of material swatch images based on the selection of the at least one of the plurality of filters.

13. The apparatus of claim 12, wherein the at least one processor is configured to execute the instructions to:
in response to receiving a selection of the at least one of the plurality of filters, generating for display a plurality of sub-filters;
receive a selection of at least one of the plurality of sub-filters; and
receive a selection of at least one of the plurality of sub-filters, wherein generating for display the subset of the plurality of material swatch images is based on the selection of the at least one of the plurality of sub-filters.

14. The apparatus of claim 12, wherein the third input comprises a search term, and wherein the at least one processor is configured to execute the instructions to determine the plurality of filters based on the search term.

15. The apparatus of claim 1, wherein the at least one processor is configured to execute the instructions to:
receive a third input; and
in response to receiving the third input, allowing a second user to login to a current session of a first user.

16. A method comprising:
generating for display a plurality of material swatch images, wherein each material swatch image is associated with a material;
receiving a first input identifying a selection of at least one material swatch image of the plurality of material swatch images;
associating the at least one material swatch image with a material board based on receiving the first input;
receiving a second input;
in response to the second input, automatically generating a communication for a sample of the material associated with the at least one material swatch image; and
transmitting, via the communications unit, the communication.

17. The method of claim 16 comprising:
receiving a third input; and
in response to receiving the third input, adjusting a size of the at least one material swatch image.

18. The method of claim 16 comprising:
receiving a third input;
displaying at plurality of filters;
receiving a selection of at least one of the plurality of filters; and
generating for display a subset of the plurality of material swatch images based on the selection of the at least one of the plurality of filters.

19. A non-transitory, machine-readable storage medium storing instructions that, when executed by at least one processor, cause the at least one processor to perform operations, comprising:
generating for display a plurality of material swatch images, wherein each material swatch image is associated with a material;
receiving a first input identifying a selection of at least one material swatch image of the plurality of material swatch images;
associating the at least one material swatch image with a material board based on receiving the first input;
receiving a second input;
in response to the second input, automatically generating a communication for a sample of the material associated with the at least one material swatch image; and
transmitting, via the communications unit, the communication.

20. The non-transitory, machine-readable storage medium of claim 19 wherein the instructions, when executed by the at least one processor, cause the at least one processor to perform further operations, comprising:
receiving a third input; and
in response to receiving the third input, adjusting a size of the at least one material swatch image.
